(19) United States
(12) Patent Application Publication
(10) Pub. No.: US 2026/0341210 A1
(43) Pub. Date: Oct. 29, 2026

(54) DISPLAY SUBSTRATE AND DISPLAY DEVICE

(71) Applicants: BEIJING BOE TECHNOLOGY DEVELOPMENT CO., LTD., Beijing (CN); BOE TECHNOLOGY GROUP CO., LTD., Beijing (CN)

(72) Inventors: Guangshuang LV, Beijing (CN); Pan XU, Beijing (CN); Ying HAN, Beijing (CN); Chengyuan LUO, Beijing (CN); Xing ZHANG, Beijing (CN); Donghui ZHAO, Beijing (CN); Cheng XU, Beijing (CN); Hongli WANG, Beijing (CN); Tong WU, Beijing (CN); Dandan ZHOU, Beijing (CN)

(73) Assignees: BEIJING BOE TECHNOLOGY DEVELOPMENT CO., LTD., Beijing (CN); BOE TECHNOLOGY GROUP CO., LTD., Beijing (CN)

(21) Appl. No.: 18/995,357

(22) PCT Filed: May 23, 2023
(86) PCT No.: PCT/CN2023/095874

§ 371 Date: Jan. 16, 2025

(30) Foreign Application Priority Data
Nov. 28, 2022 (WO) PCT/CN2022/134711
Apr. 18, 2023 (WO) PCT/CN2023/088913

(51) Int. Cl. G09G 3/3233

(52) U.S. Cl. CPC G09G 3/3233; G09G 2300/0465; G09G 2300/0819; G09G 2310/08; G09G 2320/0247; G09G 2320/045

(57) ABSTRACT

A display substrate and a display device are provided. In the display substrate, the control sub-circuit includes a control transistor, a first electrode of the control transistor is electrically connected to the gate electrode of the driving transistor; a connection position of the first electrode of the control transistor and an active layer of the control transistor is a first position, and a connection position of a second electrode of the control transistor and the active layer of the control transistor is a second position, a connection position of a first electrode of the driving transistor and an active layer of the driving transistor is a third position, and a distance between the first position and the second position is greater than a distance between the first position and the third position.

The application claims priority to the international application PCT/CN2023/088913 filed on Apr. 18, 2023 and the international application PCT/CN2022/134711 filed on Nov. 28, 2022, the entire contents of all these applications are incorporated herein by reference as part of the present application.

### TECHNICAL FIELD

At least one embodiment of the present disclosure relates to a display substrate and a display device.

### BACKGROUND

Compared with the traditional liquid crystal display (LCD), the active-matrix organic light-emitting diode (AMOLED) have the advantages of self-illumination, wide color gamut, high contrast, and thinness, which makes it widely used in the mobile phone, the tablet computer and other fields, and is also widely used in the flexible wearable field such as the smart watch. Usually, a pixel circuit is provided in a display region, and a gate driving circuit, such as a GOA driving circuit, is provided in a frame region to provide driving signals to the pixel circuit.

During the operation of the pixel circuit, during the light-emitting phase, within a frame of display, in the case where a transistor electrically connected to the gate electrode of the driving transistor is turned off, and when the off-state current of the transistor electrically connected to the gate electrode of the driving transistor is large, a serious current leakage problem will be caused on the gate electrode of the driving transistor through the transistor, and the transistor electrically connected to the gate electrode of the driving transistor will cause the potential of the gate electrode of the driving transistor to change, which causes the display screen to be unable to maintain the written grayscale, thereby resulting in a screen flickering phenomenon on the display panel.

### SUMMARY

At least one embodiment of the present disclosure provides a display substrate, the display substrate includes a sub-pixel, and the sub-pixel includes a pixel circuit, the pixel circuit includes a driving sub-circuit, a light-emitting element and a control sub-circuit, the driving sub-circuit includes a driving transistor, a gate electrode of the driving transistor is configured to receive a driving control signal, and the driving sub-circuit is configured to control a magnitude of driving current flowing through the light-emitting element in response to the driving control signal; the control sub-circuit includes a control transistor, a first electrode of the control transistor is electrically connected to the gate electrode of the driving transistor; a connection position of the first electrode of the control transistor and an active layer of the control transistor is a first position, and a connection position of a second electrode of the control transistor and the active layer of the control transistor is a second position, a connection position of a first electrode of the driving transistor and an active layer of the driving transistor is a third position, and a distance between the first position and the second position is greater than a distance between the first position and the third position.

For example, in the display substrate provided by an embodiment of the present disclosure, a linear distance between the first position and the second position is greater than a linear distance between the first position and the third position, or, a distance between the first position and the second position in the first direction is greater than a distance between the first position and the third position in the first direction, or, a sum of the distance between the first position and the second position in the first direction and a distance between the first position and the second position in the second direction is greater than a sum of the distance between the first position and the third position in the first direction and a distance between the first position and the third position in the second direction.

For example, in the display substrate provided by an embodiment of the present disclosure, the sub-pixel comprises a first connection block, the first connection block is electrically connected to the gate electrode of the driving transistor, the active layer of the driving transistor and the active layer of the control transistor through a first connection via hole, and a position of the first connection via hole is the first position; the second electrode of the control transistor is electrically connected to the active layer of the control transistor through a second connection via hole, and a position of the second connection via hole is the second position; the sub-pixel comprises a second connection block, the second connection block is electrically connected to the active layer of the driving transistor through a third connection via hole, and a position of the third connection via hole is the third position.

For example, in the display substrate provided by an embodiment of the present disclosure, a channel region of the driving transistor and a channel region of the control transistor are arranged in a first direction, and a second direction intersects with the first direction, the active layer of the control transistor comprises a longitudinal portion extending in the first direction and a lateral portion extending in the second direction, the longitudinal portion comprises the channel region of the control transistor; the lateral portion is connected to the longitudinal portion, the lateral portion comprises a first extension portion and a second extension portion, the first extension portion protrudes from the longitudinal portion toward a first side in the second direction, the second extension portion protrudes from the longitudinal portion toward a second side opposite to the first side in the second direction.

For example, in the display substrate provided by an embodiment of the present disclosure, the channel region of the driving transistor is located on the first side of the longitudinal portion in the second direction, and a length of the first extension portion in the second direction is not less than a length of the second extension portion in the second direction.

For example, in the display substrate provided by an embodiment of the present disclosure, the longitudinal portion has a distal end away from the channel region of the driving transistor in the first direction, the first extension portion and the second extension portion are located at the distal end of the longitudinal portion and connected with the distal end of the longitudinal portion.

For example, in the display substrate provided by an embodiment of the present disclosure, the pixel circuit comprises a data writing sub-circuit, the data writing sub-circuit comprises a data writing transistor, and the control transistor comprises the data writing transistor; a gate electrode of the data writing transistor is electrically connected to a data writing control signal terminal to receive a data writing control signal, a first electrode of the data writing transistor is electrically connected to the gate electrode of the driving transistor, a second electrode of the data writing transistor is configured to receive a data signal, and the data writing sub-circuit is configured to write the data signal to the gate electrode of the driving transistor in response to the data writing control signal.

For example, in the display substrate provided by an embodiment of the present disclosure, the first extension portion of an active layer of the data writing transistor at least partially overlaps with the channel region of the driving transistor in the first direction.

For example, in the display substrate provided by an embodiment of the present disclosure, the display substrate comprises a data signal line providing the data signal, and the lateral portion of the active layer of the data writing transistor is electrically connected to the data signal line; the pixel circuit comprises a first connection electrode arranged in a layer different from both the active layer and the data signal line, and the first extension portion of the lateral portion is electrically connected to the first connection electrode through a first via hole, the first connection electrode is electrically connected to the data signal line through a second via hole, and the first via hole serves as the second position in a case where the control transistor is the data writing transistor.

For example, in the display substrate provided by an embodiment of the present disclosure, the first via hole is located at an end portion of the first extension portion away from the longitudinal portion in the second direction.

For example, in the display substrate provided by an embodiment of the present disclosure, an active layer of the data writing transistor further comprises an auxiliary extension portion, the auxiliary extension portion is connected to the first extension portion of the lateral portion and extends in the first direction toward a side, of the first extension portion, on which a channel region of the data writing transistor is located.

For example, in the display substrate provided by an embodiment of the present disclosure, a spacing region exists between the gate electrode of the data writing transistor and the lateral portion of the active layer of the data writing transistor, and the auxiliary extension portion is located in the spacing region.

For example, in the display substrate provided by an embodiment of the present disclosure, the display substrate comprises a data signal line providing the data signal, and a lateral portion of the active layer of the data writing transistor is electrically connected to the data signal line; the pixel circuit comprises a first connection electrode arranged in a layer different from both the active layer and the data signal line, the auxiliary extension portion is electrically connected to the first connection electrode through a third via hole, and the first connection electrode is electrically connected to the data signal line through a second via hole, and the third via hole serves as the second connection via hole in a case where the control transistor is the data writing transistor.

For example, in the display substrate provided by an embodiment of the present disclosure, the third via hole is located at an end portion of the auxiliary extension portion away from the first extension portion in the first direction.

For example, in the display substrate provided by an embodiment of the present disclosure, the display substrate comprises a plurality of the sub-pixels, and the plurality of sub-pixels comprise a first sub-pixel and a second sub-pixel that are adjacent in the second direction; a gate electrode of the data writing transistor of the first sub-pixel and a gate electrode of the data writing transistor of the second sub-pixel are independent of each other to receive different data writing control signals respectively; the display substrate comprises a first auxiliary gate line arranged in a layer different from the gate electrode of the data writing transistor of the first sub-pixel, and the first auxiliary gate line is electrically connected to the gate electrode of the data writing transistor of the first sub-pixel through a fourth via hole; the display substrate comprises a second auxiliary gate line arranged in a layer different from the gate electrode of the data writing transistor of the second sub-pixel, and the second auxiliary gate line is electrically connected to the gate electrode of the data writing transistor of the second sub-pixel through a fifth via hole.

For example, in the display substrate provided by an embodiment of the present disclosure, the first extension portion of the active layer of the data writing transistor at least partially overlaps with the fourth via hole in the first direction.

For example, in the display substrate provided by an embodiment of the present disclosure, a gate electrode of a common-gate transistor of the first sub-pixel and a gate electrode of a common-gate transistor of the second sub-pixel are electrically connected to each other to share with a same data writing control signal, the common-gate transistor comprises at least one of transistors in the pixel circuit other than the data writing transistor; the display substrate comprises a second connection electrode arranged in a layer different from the gate electrode of the common-gate transistor, and the second connection electrode is electrically connected to the gate electrode of the common-gate transistor of the first sub-pixel through a sixth via hole, and electrically connected to the gate electrode of the common-gate transistor of the second sub-pixel through a seventh via hole; in a case where the display substrate comprises a data signal line providing the data signal, and a lateral portion of the active layer of the data writing transistor is electrically connected to the data signal line, and the pixel circuit comprises a first connection electrode arranged in a layer different from both the active layer and the data signal line, and the first extension portion of the lateral portion is electrically connected to the first connection electrode through a first via hole, the first connection electrode is electrically connected to the data signal line through a second via hole, the first auxiliary gate line, the second auxiliary gate line, and the second connection electrode are all arranged in a same layer as the first connection electrode.

For example, in the display substrate provided by an embodiment of the present disclosure, the pixel circuit comprises a first reset sub-circuit, the first reset sub-circuit comprises a first reset transistor, and the control transistor comprises the first reset transistor; a gate electrode of the first reset transistor is electrically connected to a first reset signal terminal to receive a first reset control signal, a first electrode of the first reset transistor is electrically connected to the gate electrode of the driving transistor, a second electrode of the reset transistor is electrically connected to a first signal terminal, and the first reset sub-circuit is configured to write a first reset signal from the first signal terminal to the gate electrode of the driving transistor in response to the first reset control signal.

For example, in the display substrate provided by an embodiment of the present disclosure, a connection position of the first electrode of the data writing transistor and an active layer of the data writing transistor is a first sub-position, and a connection position of the second electrode of the data writing transistor and the active layer of the data writing transistor is a second sub-position; a connection position of the first electrode of the first reset transistor and an active layer of the first reset transistor is a third sub-position, and a connection position of the second electrode of the first reset transistor and the active layer of the first reset transistor is a fourth sub-position; a distance between the first sub-position and the second sub-position is greater than a distance between the third sub-position and the fourth sub-position.

For example, in the display substrate provided by an embodiment of the present disclosure, the active layer of the data writing transistor extends from the first sub-position to the second sub-position, and the active layer of the second reset transistor extends from the third sub-position to the fourth sub-position, a total length of the active layer of the data writing transistor from the first sub-position to the second sub-position is greater than a total length of the active layer of the second reset transistor from the third sub-position to the fourth sub-position.

For example, in the display substrate provided by an embodiment of the present disclosure, the first extension portion of the active layer of the first reset transistor at least partially overlaps with the channel region of the driving transistor in the first direction.

For example, in the display substrate provided by an embodiment of the present disclosure, in the case where the control transistor comprises the data writing transistor, in the first direction, the channel region of the driving transistor is located between a channel region of the data writing transistor and a channel region of the first reset transistor; in the first direction, the lateral portion of the active layer of the data writing transistor is located on a side of the channel region of the data writing transistor away from the channel region of the driving transistor, and the lateral portion of the active layer of the first reset transistor is located on a side of the channel region of the first reset transistor away from the channel region of the driving transistor.

For example, in the display substrate provided by an embodiment of the present disclosure, a length of the first extension portion of the active layer of the first reset transistor in the second direction is greater than or equal to a length of the first extension portion of an active layer of the data writing transistor in the second direction.

For example, in the display substrate provided by an embodiment of the present disclosure, the first extension portion of the active layer of the first reset transistor extends beyond the active layer of the data writing transistor in the second direction.

For example, in the display substrate provided by an embodiment of the present disclosure, the display substrate comprises a compensation signal line providing the compensation signal, the first extension portion of the lateral portion of an active layer of the first reset transistor is electrically connected to the compensation signal line through an eighth via hole, and a position of the eighth via hole is the second position in a case where the control transistor is the first reset transistor.

For example, in the display substrate provided by an embodiment of the present disclosure, the pixel circuit further comprises a storage sub-circuit, and the storage sub-circuit comprises a storage capacitor; the first electrode of the data writing transistor is electrically connected to a first capacitive electrode of the storage capacitor and the gate electrode of the driving transistor, and the second electrode of the data writing transistor is electrically connected to the data signal line to receive the data signal; a first electrode of the driving transistor is electrically connected to a first capacitive electrode of the storage capacitor and is configured to be electrically connected to a first electrode of the light-emitting element, the second electrode of the driving transistor is electrically connected to a first power supply voltage terminal to receive a first supply voltage.

For example, in the display substrate provided by an embodiment of the present disclosure, the pixel circuit further comprises a sensing sub-circuit, the sensing sub-circuit comprising a sensing transistor; a first electrode of the sensing transistor is electrically connected to the first electrode of the driving transistor and the second capacitive electrode of the storage capacitor, and the sensing transistor is configured to detect an electrical property of the sub-pixel to which the sensing transistor belongs in response to a detection control signal.

For example, in the display substrate provided by an embodiment of the present disclosure, a connection position of the first electrode of the data writing transistor and an active layer of the data writing transistor is a first sub-position, and a connection position of the second electrode of the data writing transistor and the active layer of the data writing transistor is a second sub-position; a connection position of the first electrode of the sensing transistor and an active layer of the sensing transistor is a fifth sub-position, and a connection position of the second electrode of the sensing transistor and the active layer of the sensing transistor is a sixth sub-position; a distance between the first sub-position and the second sub-position is greater than a distance between the fifth sub-position and the sixth sub-position.

For example, in the display substrate provided by an embodiment of the present disclosure, in a case where the control sub-circuit comprises a first reset sub-circuit, the control transistor comprises a first reset transistor, and a gate electrode of the first reset transistor is electrically connected to a first reset signal terminal to receive a first reset control signal, a first electrode of the first reset transistor is electrically connected to the gate electrode of the driving transistor, and a second electrode of the first reset transistor is electrically connected to a first signal terminal, the first reset sub-circuit is configured to write a first reset signal or a compensation signal from the first signal terminal to the gate terminal of the driving transistor in response to the first reset control signal, the gate electrode of the driving transistor, the first electrode of the data writing transistor and the first electrode of the first reset transistor are electrically connected to a first node; the pixel circuit further comprises a light-emitting control sub-circuit, the light-emitting control sub-circuit comprises a light-emitting control transistor, a gate electrode of the light-emitting control transistor is electrically connected to a light-emitting control signal terminal, a first electrode of the light-emitting control transistor is electrically connected to the first power supply voltage terminal, and a second electrode of the light-emitting control transistor is electrically connected to the second electrode of the driving transistor; the pixel circuit further comprises a second reset sub-circuit, the second reset sub-circuit comprises a second reset transistor, a gate electrode of the second reset transistor is electrically connected to a second reset signal terminal to receive a second reset control signal, a first electrode of the second reset transistor, the first electrode of the driving transistor, the second capacitive electrode of the storage capacitor and the first electrode of the light-emitting element are electrically connected to a second node, a second electrode of the second reset transistor is electrically connected to a second signal terminal to receive a second reset signal, the second reset sub-circuit is under a control of the second reset signal, and the second reset sub-circuit is configured to respond to the second reset control signal to write the second reset signal to the second node.

For example, in the display substrate provided by an embodiment of the present disclosure, a connection position of the first electrode of the data writing transistor and an active layer of the data writing transistor is a first sub-position, and a connection position of the second electrode of the data writing transistor and the active layer of the data writing transistor is a second sub-position; a connection position of the first electrode of the first reset transistor and an active layer of the first reset transistor is a third sub-position, and a connection position of the second electrode of the first reset transistor and the active layer of the first reset transistor is a fourth sub-position; a connection position of the first electrode of the second reset transistor and an active layer of the second reset transistor is a seventh sub-position, a connection position of the second electrode of the second reset transistor and the active layer of the second reset transistor is an eighth sub-position; a connection position of the first electrode of the light-emitting control transistor and an active layer of the light-emitting control transistor is a ninth sub-position, and a connection position of the second electrode of the light-emitting control transistor and the active layer of the light-emitting control transistor is a tenth sub-position; a distance between the first sub-position and the second sub-position is greater than a distance between the seventh sub-position and the eighth sub-position, and/or a distance between the first sub-position and the second sub-position is greater than a distance between the ninth sub-position and the tenth sub-position; or, a distance between the third sub-position and the fourth sub-position is greater than the distance between the seventh sub-position and the eighth sub-position, and/or a distance between the third sub-position and the fourth sub-position is greater than the distance between the ninth sub-position and the tenth sub-position.

At least one embodiment of the present disclosure further provides a display device, and the display device includes any one of the display substrates provided by the embodiments of the present disclosure.

### BRIEF DESCRIPTION OF DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a schematic diagram of an overall circuit architecture of a display panel provided by an embodiment of the present disclosure;

FIG. 2 is an equivalent circuit diagram of a pixel circuit of a sub-pixel provided by an embodiment of the present disclosure;

FIG. 3 is a timing diagram of the pixel circuit illustrated in FIG. 2 during actual operation;

FIG. 4 is a schematic layout diagram of the pixel circuit illustrated in FIG. 2;

FIG. 5A to FIG. 5H respectively illustrates structural planar views of each layer of the pixel circuit illustrated in FIG. 4;

FIG. 5I is a schematic cross-sectional view along the line A1-A2 in FIG. 4;

FIG. 5J is a schematic cross-sectional view along the line B1-B2 in FIG. 4;

FIG. 6 is a schematic layout diagram of a pixel circuit of another display substrate provided by at least one embodiment of the present disclosure;

FIG. 7A to FIG. 7H respectively illustrates a structural planar view of each layer of the pixel circuit illustrated in FIG. 6;

FIG. 8 is an equivalent circuit diagram of a pixel circuit of another sub-pixel provided by an embodiment of the present disclosure;

FIG. 9A to FIG. 9C are timing diagrams of the pixel circuit illustrated in FIG. 8 during operation;

FIG. 10 is a schematic layout diagram of the pixel circuit illustrated in FIG. 8;

FIG. 11A to FIG. 11H respectively illustrates a structural planar view of each layer of the pixel circuit illustrated in FIG. 10;

FIG. 12 is a schematic block diagram of a display device provided by at least one embodiment of the present disclosure.

### DETAILED DESCRIPTION

In order to make objects, technical details and advantages of the embodiments of the disclosure apparent, the technical solutions of the embodiments will be described in a clear and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the description and the claims of the present application for disclosure, are not intended to indicate any sequence, amount or importance, but distinguish various components. Also, the terms “comprise,” “comprising,” “comprise,” “comprising,” etc., are intended to specify that the elements or the objects stated before these terms encompass the elements or the objects and equivalents thereof listed after these terms, but do not preclude the other elements or objects. “Inside,” “outside,” “on,” “under” and the like are only used to indicate relative position relationship, and when the position of the object which is described is changed, the relative position relationship may be changed accordingly.

It should be noted that “channel region of a transistor” in the present disclosure refers to a region of the active layer of the transistor and the gate electrode of the transistor that overlap each other in a direction perpendicular to the main surface of the base substrate, that is, the region where the orthographic projection of the active layer of the transistor on the main surface of the base substrate overlaps with the orthographic projection of the gate electrode on the main surface of the base substrate corresponds to the channel region of the transistor.

The drawings in present disclosure are not drawn strictly to actual scale, and the number of sub-pixels in the display substrate is not limited to the number illustrated in the drawings, a specific size and number of each structure can be determined according to actual needs. The drawings described in the present disclosure are only structural schematic diagrams.

At least one embodiment of the present disclosure provides a display substrate, the display substrate includes a sub-pixel, and the sub-pixel includes a pixel circuit, the pixel circuit includes a driving sub-circuit, a light-emitting element and a control sub-circuit, the driving sub-circuit includes a driving transistor, a gate electrode of the driving transistor is configured to receive a driving control signal, and the driving sub-circuit is configured to control a magnitude of driving current flowing through the light-emitting element in response to the driving control signal; the control sub-circuit includes a control transistor, a first electrode of the control transistor is electrically connected to the gate electrode of the driving transistor; a connection position of the first electrode of the control transistor and an active layer of the control transistor is a first position, and a connection position of a second electrode of the control transistor and the active layer of the control transistor is a second position, a connection position of a first electrode of the driving transistor and an active layer of the driving transistor is a third position, and a distance between the first position and the second position is greater than a distance between the first position and the third position.

At least one embodiment of the present disclosure further provides a display device, and the display device includes any one of the display substrates provided by the embodiments of the present disclosure.

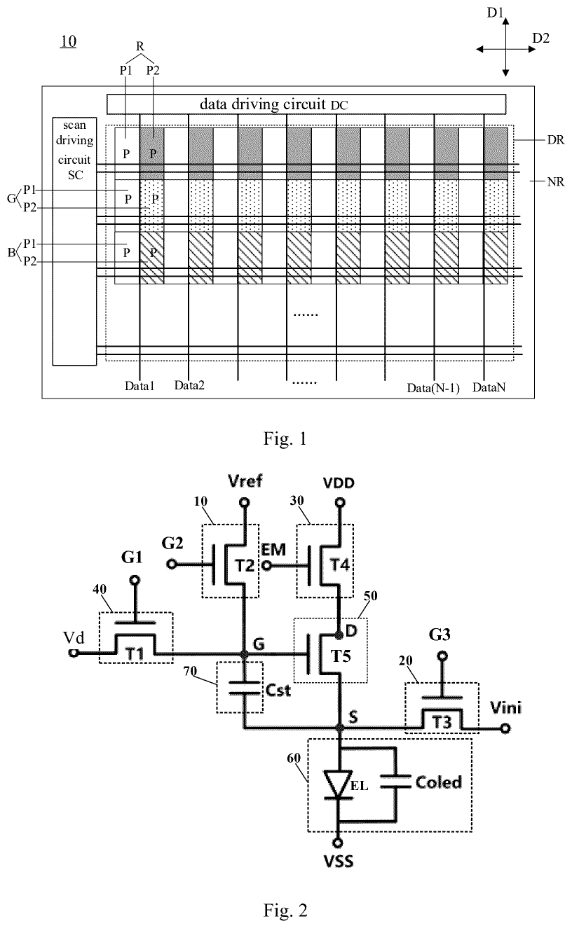

FIG. 1 is a schematic diagram of an overall circuit architecture of a display panel provided by an embodiment of the present disclosure. As illustrated in FIG. 1, a display substrate 10 includes a display region DR and a non-display region NR at least partially around the display region DR. The display substrate 10 includes a plurality of display units located in the display region DR and distributed in an array, and the plurality of display units perform display functions. For example, each of the plurality of display units includes a plurality of sub-pixels P, for example, FIG. 1 takes the case where one display unit PU includes three sub-pixels P as an example, of course, the number of sub-pixels included in one display unit PU is not limited, it can be less than three or more than three. Each sub-pixel P includes a light-emitting element and a pixel circuit that drives the light-emitting element. As illustrated in FIG. 1, the display substrate 10 further includes a plurality of scan lines GL and a plurality of data lines DL. The plurality of scan lines GL and the plurality of data lines DL intersect with each other to define a plurality of pixel regions distributed in an array in the display region DR, and one pixel circuit of one sub-pixel P is provided in each pixel region. The pixel circuit is, for example, a conventional pixel circuit, such as a 3T1C (that is, two transistors and one capacitor) pixel circuit, or other nTmC (n and m are positive integers) pixel circuits such as a 4T2C pixel circuit, a 5T1C pixel circuit and so on, and in different embodiments, the pixel circuit may further include a compensation sub-circuit which includes an internal compensation sub-circuit or an external compensation sub-circuit, the compensation sub-circuit may include a transistor, a capacitor and so on. For example, as needed, the pixel circuit may further include a reset circuit, a light-emitting control sub-circuit, and a detection circuit and so on. For example, the display substrate 10 may further include a scan driving circuit SC and a data driving circuit DC located in the non-display region NR, the scan driving circuit SC is, for example, a gate driving circuit (for example, a GOA driving circuit). The scan driving circuit SC is connected to the pixel circuits through the scan lines GL to provide various scan signals, and the data driving circuit DC is connected to the pixel circuits through the data lines DL to provide data signals. The positional relationship between the scan driving circuit SC, the data driving circuit DC, the scan line GL and the data line DL illustrated in FIG. 1 in the display substrate is only an example, and the actual arrangement position can be designed as needed.

For example, the display substrate 10 may further include a control circuit (not illustrated). For example, the control circuit is configured to control the data driving circuit DC to apply the data signal, and to control the gate driving sub-circuit to apply the scan signal. An example of the control circuit is a timing control circuit (T-con). The control circuit may be in various forms, for example, including a processor and a memory, the memory includes executable code, and the processor runs the executable code to perform the above detection method.

For example, the processor may be a central processing unit (CPU) or other form of processing device with data processing capabilities and/or instruction execution capabilities, and may include, for example, a microprocessor, a programmable logic controller (PLC) and so on.

For example, a storage device may include one or more computer program products, which may include various forms of computer-readable storage medium, such as a volatile memory and/or a non-volatile memory. The volatile memory may include, for example, a random access memory (RAM) and/or a cache memory and so on. The non-volatile memory may include, for example, a read-only memory (ROM), a hard disk, and a flash memory and so on. One or more computer program instructions may be stored in the computer-readable storage medium, and the processor can execute the program instructions to obtain desired functions. Various application programs and various data can further be stored in the computer-readable storage medium.

FIG. 2 is an equivalent circuit diagram of a pixel circuit of a sub-pixel provided by an embodiment of the present disclosure. As illustrated in FIG. 2, for example, the pixel circuit includes a driving sub-circuit 50, a data writing sub-circuit 40 and a light-emitting unit 60, the light-emitting unit 60 includes a light-emitting element EL, the driving sub-circuit 50 is configured to control the magnitude of driving current flowing through the light-emitting element EL in response to the driving control signal.

For example, as illustrated in FIG. 2, the pixel circuit further includes a first reset sub-circuit 10, a second reset sub-circuit 20, and a light-emitting control sub-circuit 30.

A control terminal of the first reset sub-circuit 10 is electrically connected to a first reset signal terminal to receive a first reset control signal G1, a first terminal of the first reset sub-circuit 10 is electrically connected to a control terminal (corresponding to the gate electrode) of the driving sub-circuit 50, a second terminal of the first reset sub-circuit 10 is electrically connected to a first signal terminal compensation signal terminal Vref, the first reset sub-circuit 10 is configured to write a first reset signal or a compensation signal Vref from the first signal terminal to the control terminal of the driving sub-circuit 50 in respond to the first reset control signal G2.

A control terminal (corresponding to the gate electrode) of the second reset sub-circuit 20 is electrically connected to a second reset signal terminal to receive a second reset control signal G3, a first terminal of the second reset sub-circuit 20 is electrically connected to a second node S, a second terminal of the second reset sub-circuit 20 is electrically connected to an initial signal terminal Vini, and the second reset sub-circuit 20 is configured to write a second reset signal to the second node S in response to the second reset control signal G3.

A control terminal of the light-emitting control sub-circuit 30 is electrically connected to a control signal terminal to receive a light-emitting control signal EM, a first terminal of the light-emitting control sub-circuit 30 is electrically connected to a first power supply voltage terminal to receive a first power supply voltage VDD, a second terminal is electrically connected to a second terminal of the driving sub-circuit 50.

A control terminal of the data writing sub-circuit 40 is electrically connected to a data writing control signal terminal to receive a data writing control signal G1, a first terminal of the data writing sub-circuit 40 is electrically connected to a first node G, a second electrode of the data writing sub-circuit 40 is electrically connected to a data signal terminal to receive a data signal Vd, and the data writing sub-circuit 40 is configured to write the data signal Vd to the control terminal of the driving sub-circuit 50 in response to the data writing control signal G1.

In this way, the control terminal (corresponding to the gate electrode) of the driving sub-circuit 50, the first terminal of the first reset sub-circuit 10 and the first terminal of the data writing sub-circuit 40 are all electrically connected to the first node G.

For example, as illustrated in FIG. 2, the pixel circuit further includes a storage sub-circuit 70, a first terminal of the storage sub-circuit 70 is electrically connected to the first node G, and a second terminal of the storage sub-circuit 70 is electrically connected to the second node S.

For example, as illustrated in FIG. 2, the driving sub-circuit 50 includes a driving transistor T5, a gate electrode of the driving transistor T5 is configured to receive the driving control signal. A gate electrode of a data writing transistor T1 is electrically connected to the data writing control signal terminal to receive the data writing control signal G1, a first electrode of the data writing transistor T1 is electrically connected to the gate electrode of the driving transistor T5, that is, electrically connected to the first node G, a second electrode of the data writing transistor T1 is configured to receive the data signal Vd, and the data writing sub-circuit 40 is configured to write the data signal Vd to the gate electrode of the driving transistor T5 in response to the data writing control signal G1, that is, to input the data signal Vd to the gate electrode of the driving transistor T5.

For example, the data writing sub-circuit 40 includes the data writing transistor T1, the gate electrode GE1 of the data writing transistor T1 is electrically connected to the data writing control signal terminal to receive the data writing control signal G1, the first electrode of the data writing transistor T1 is electrically connected to the gate electrode of the driving transistor T5, the second electrode of the data writing transistor T1 is configured to receive the data signal Vd, and the data writing sub-circuit 40 is configured to write the data signal Vd to the gate terminal of the driving transistor T5 in response to the data writing control signal G1, that is, to input the data signal Vd to the gate electrode of the driving transistor T5.

For example, the storage sub-circuit 70 includes a storage capacitor Cst, the first electrode of the data writing transistor T1 is electrically connected to a first capacitive electrode of the storage capacitor Cst and the gate electrode of the driving transistor T5, and the second electrode of the data writing transistor T1 is electrically connected to a data signal line Data to receive the data signal Vd; the first electrode of the driving transistor T5 is electrically connected to a first electrode of the light-emitting element EL, and is configured to be electrically connected to the first electrode of the light-emitting element EL, and the second electrode of the driving transistor T5 is electrically connected to the first power supply voltage terminal to receive the first power supply voltage VDD.

For example, the first reset sub-circuit 10 includes a first reset transistor T2, a gate electrode of the first reset transistor T2 is electrically connected to the first reset signal terminal to receive the first reset control signal G2, a first electrode of the first reset transistor T2 is electrically connected to the gate electrode of the driving transistor T5, a second electrode of the first reset transistor T2 is electrically connected to the first signal terminal, and the first reset sub-circuit 10 is configured to write the first reset signal or the compensation signal Vref from the first signal terminal to the gate terminal of the driving transistor T5 in respond to the first reset control signal G2; the gate electrode of the driving transistor T5, the first electrode of the data writing transistor T1 and the first electrode of the first reset transistor T2 are electrically connected to the first node G.

For example, the light-emitting control sub-circuit 30 includes a light-emitting control transistor T4, a gate electrode of the light-emitting control transistor T4 is electrically connected to the light-emitting control signal terminal to receive the light-emitting control signal EM, a first electrode of the light-emitting control transistor T4 is electrically connected to the first power supply voltage terminal to receive the first power supply voltage VDD, a second electrode of the light-emitting control transistor T4 is electrically connected to the second electrode of the driving transistor T5.

For example, the second reset sub-circuit 20 includes a second reset transistor T3, a gate electrode of the second reset transistor T3 is electrically connected to the second reset signal terminal to receive the second reset control signal G3, a first electrode of the second reset transistor T3, the first electrode of the driving transistor T5, the second capacitive electrode C2 of the storage capacitor Cst and the first electrode of the light-emitting element EL are electrically connected to the second node S, and a second electrode of the second reset transistor T3 is electrically connected to a second signal terminal to receive the second reset signal, the second reset sub-circuit 20 is under a control of the second reset signal, and the second reset sub-circuit 20 is configured to write the second reset signal to the second node S in response to the second reset control signal G3.

A second electrode of the light-emitting element EL is electrically connected to a second power supply voltage terminal to receive a second power supply voltage VSS. For example, the light-emitting element EL is an organic light-emitting diode (OLED) device, the first electrode of the light-emitting element EL is the anode, and the second electrode of the light-emitting element EL is the cathode.

For example, the first power supply voltage is a high power supply voltage VDD, and the second power supply voltage is a low power supply voltage VSS. For example, the second power supply voltage terminal is a ground terminal.

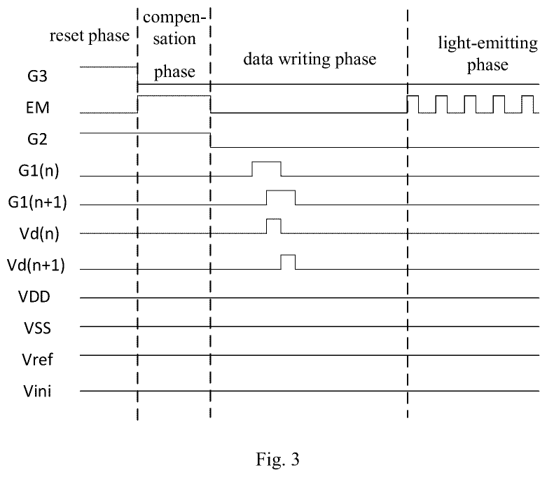

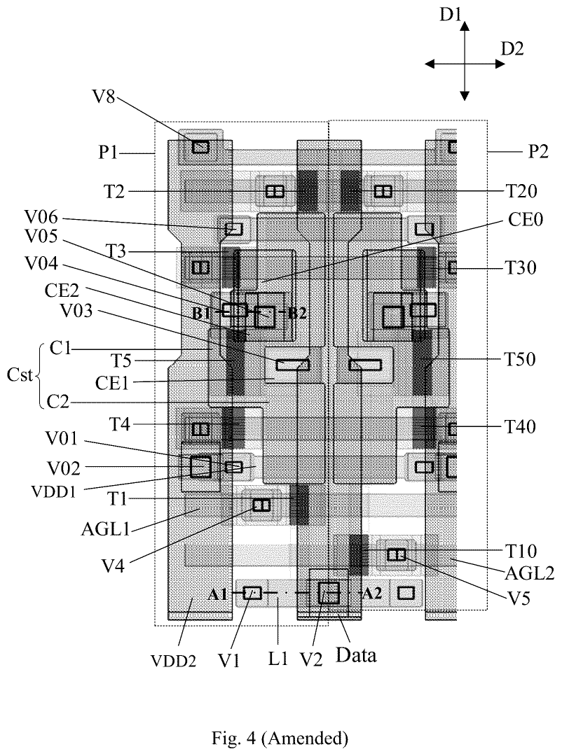

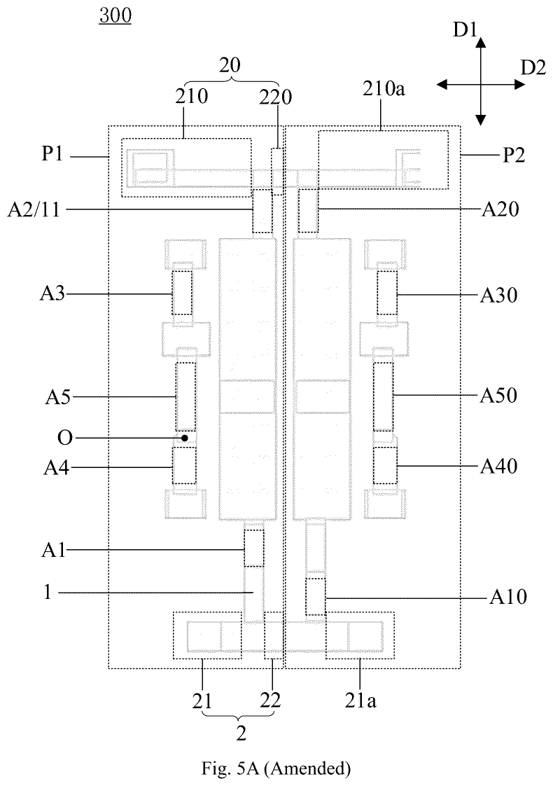

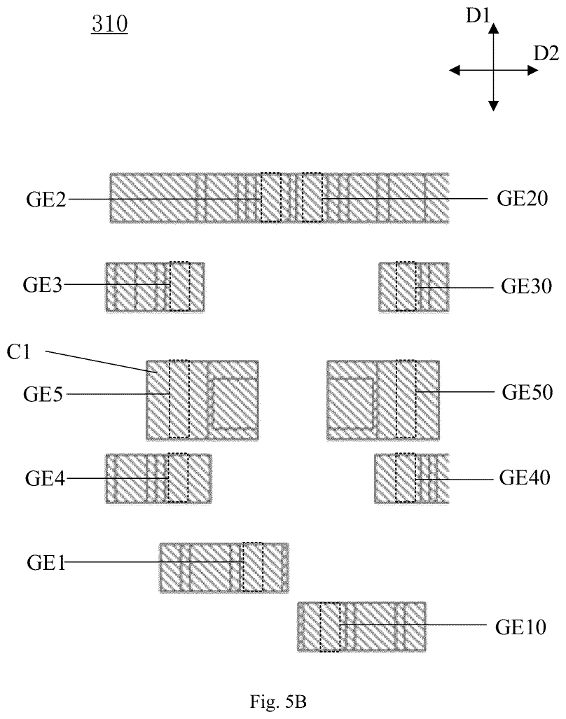

The transistors used in the embodiments of the present disclosure may be thin film transistors, field-effect transistors, or other switching devices with the same characteristics, and the thin film transistors are taken as an example to be illustrated in the embodiments of the present disclosure. A source electrode and a drain electrode of the transistor adopted herein may be symmetric in structure, so there is no difference between the source electrode and the drain electrode in structure. In the embodiments of the present disclosure, in order to distinguish the two electrodes apart from the gate electrode, one electrode of the source electrode and the drain electrode is directly described as the first electrode and the other electrode of the source electrode and the drain electrode is directly described as the second electrode. In addition, the transistors can be divided into N-type and P-type transistors according to their characteristics. In the case where the transistor is a P-type transistor, a turn-on voltage is a low-level voltage (for example, 0V, −5V, −10V or other suitable voltages), and a turn-off voltage is a high-level voltage (for example, 5V, 10V or other suitable voltages); in the case where the transistor is an N-type transistor, a turn-on voltage is a high-level voltage (for example, 5V, 10V or other suitable voltages), and a turn-off voltage is a low-level voltage (for example, 0V, −5V, −10V or other suitable voltages). It should be noted that in the following description, FIG. 3 takes the transistors being N-type transistors as an example, but this is not as a limitation of the present disclosure.

FIG. 3 is a timing diagram of the pixel circuit illustrated in FIG. 2 during actual operation. Referring to FIG. 3, the driving process of the pixel circuit mainly includes the following steps.
Step 1: during a reset phase of the pixel circuit, the first reset sub-circuit 10 is turned on based on the first reset control signal G2 to write a first reference potential to the control terminal of the driving transistor; the second reset sub-circuit 20 is turned on based on the second reset signal to write a second reference potential to the first terminal of the driving transistor T5.

During the reset phase, under the control of the first reset control signal G2, the first reset sub-circuit 10 writes the compensation voltage Vref as the first reference potential to the first node G, which is equivalent to write the compensation signal Vref to the control terminal of the driving transistor T5 for initialization; similarly, under the control of the second reset control signal G3, the second reset sub-circuit 20 writes the initial signal Vini as the second reference potential to the second node S, which is equivalent to write the initial signal Vini to the first terminal of the driving transistor T5 for initialization.

In actual implementation, the voltage value of the first reference potential is usually greater than the voltage value of the second reference potential, that is, the voltage value of the compensation signal Vref is greater than the voltage value of the initial signal Vini. In generally, the value of the initial signal Vini can be a constant signal with a small voltage, or it can be set to a voltage of 0 volt, the compensation signal Vref needs to simultaneously satisfy the driving of a compensation process of the driving transistor T5, so it is required to ensure that the voltage value of the compensation signal Vref is greater than the threshold voltage of the driving transistor T5 (that is, the turn-on voltage of the driving transistor T5), and is simultaneously smaller than the first electrode driving voltage of the light-emitting unit 60 to prevent the light-emitting unit from being lit during a non-light-emitting phase due to excessive voltage.
Step 2: during a compensation phase of the pixel circuit, the first reset sub-circuit 10 is continuously turned on based on the first reset control signal G2, and the second reset sub-circuit 20 is turned off, the light-emitting control sub-circuit 30 is turned on based on the light-emitting control signal EM to write the first power supply voltage VDD to the second terminal of the driving transistor T5, and after the driving transistor T5 is turned on, the first terminal of the driving transistor T5 is charged until the driving transistor T5 is turned off.

During the compensation phase, the first reset sub-circuit 10 remains being turned on, and the voltage of the first node G is maintained by the compensation signal Vref, the second reset sub-circuit 20 is turned off, the light-emitting control sub-circuit 30 is turned on through the light-emitting control signal EM, and the second node S is charged through the first power supply voltage VDD until the driving transistor T5 is turned off. Specifically, during the reset phase, the voltage of the first node G (that is, the control terminal of the driving transistor) is Vref, and the voltage of the second node S (that is, the first terminal of the driving transistor) is Vini, because the value of Vref is greater than the value of Vini, so the gate-source voltage Vgs of the driving transistor T5 is equal to Vref−Vini, combined with a limitation of its actual voltage value, the value of the gate-source voltage Vgs is greater than the threshold voltage Vth of the driving transistor T5, at this time, the driving transistor T5 is in a turned-on state; after entering the compensation phase, the second reset sub-circuit 20 is turned off, and the light-emitting control signal EM is turned on, which makes the operating voltage VDD flow into the driving transistor T5 and charge the second node S, after the charging continues for a certain period of time, as the voltage of the second node S continues to increase, a difference between the gate-source voltage Vgs and the Vth continues to decrease until Vgs=Vth, the driving transistor T5 is turned off, and at this time, the voltage of the second node S is Vref−Vth, thereby realizing the compensation of the driving transistor T5.
Step 3: during a data writing phase of the pixel circuit, the data writing sub-circuit 40 is turned on based on the data writing control signal G1 to write the data signal Vd to the control terminal of the driving transistor T5.

The data writing sub-circuit 40 is turned on under the control of the data writing control signal G1, and the data signal Vd is written to the first node G, so that the data signal Vd serves as a gate voltage of the driving transistor T5 to control a turning-on degree of the driving transistor T5 to achieve a control of a lighting degree of the corresponding light-emitting unit 60. In the case where the data writing sub-circuit 40 is controlled to be turned on by the light-emitting control signal EM, the first reset sub-circuit 10, the second reset sub-circuit 20 and the light-emitting control sub-circuit 30 are in a turning-off state.
Step 4: during a light-emitting phase of the pixel circuit, the light-emitting control sub-circuit is turned on based on a pulse width modulation signal, so that the driving transistor T5 is turned on and the light-emitting unit 60 is driven to be lit under an action of the first power supply voltage VDD and the second power supply voltage VSS.

In this embodiment, the control signal terminal can input not only the light-emitting control signal EM, but also a pulse width modulation(PWM) signal, and during the light-emitting phase, the light-emitting control sub-circuit is periodically turned on through the PWM signal, a turned-on duration of the light-emitting control sub-circuit is controlled by a duty cycle and a switching frequency of the PWM signal, the longer the turned-on time of the light-emitting control sub-circuit, the higher the brightness of the light-emitting unit, correspondingly, the shorter the turned-on time of the light-emitting control sub-circuit, the lower the brightness of the light-emitting unit, so that a brightness control can be achieved when the light-emitting unit is lit.

For a pixel circuit, such as the pixel circuit illustrated in FIG. 2, during the operation of the pixel circuit, during the light-emitting phase, within a frame of display, when a transistor electrically connected to the gate electrode of the driving transistor is turned off, and if the off-state current of the transistor electrically connected to the gate electrode of the driving transistor is large, a serious current leakage problem will be caused on the gate electrode of the driving transistor (that is, the first node G) through the transistor, and the transistor electrically connected to the gate electrode of the driving transistor will cause the potential of the gate electrode of the driving transistor to change, which causes the display screen to be unable to maintain the written grayscale, thereby resulting in a screen flickering phenomenon on the display panel. Especially, in the case where the transistor electrically connected to the gate electrode of the driving transistor is a low-temperature polysilicon (LTPS) transistor, because the mobility of the active layer of polysilicon is high, the leakage current is large, and in a low-frequency display or an ultra-high PPI display, the space of the pixel circuit layout is limited, and the capacitance value of the storage capacitor Cst may be small, in this case, the serious current leakage problem and the potential changing of the gate electrode of the driving transistor T5 (the first node G) cause the display screen to be unable to maintain the written grayscale, thereby resulting in the screen flickering phenomenon on the display panel. Therefore, a design solution is needed to reduce the current leakage of the first node G to achieve a good display effect.

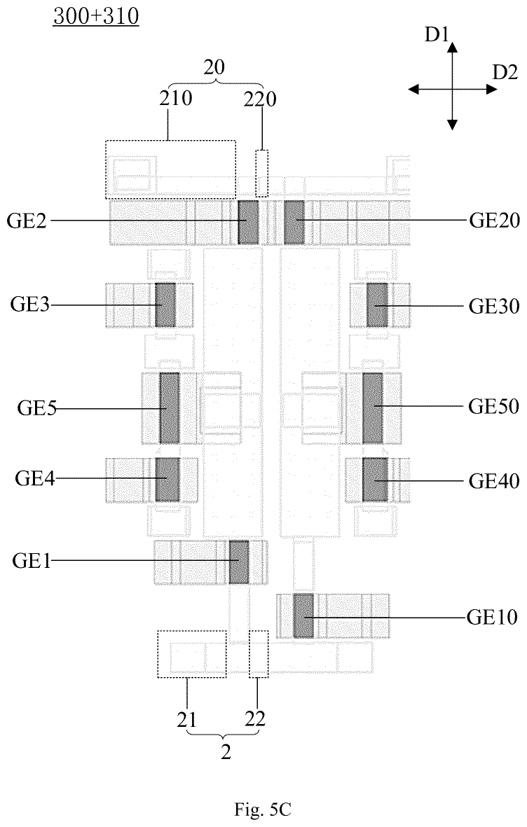

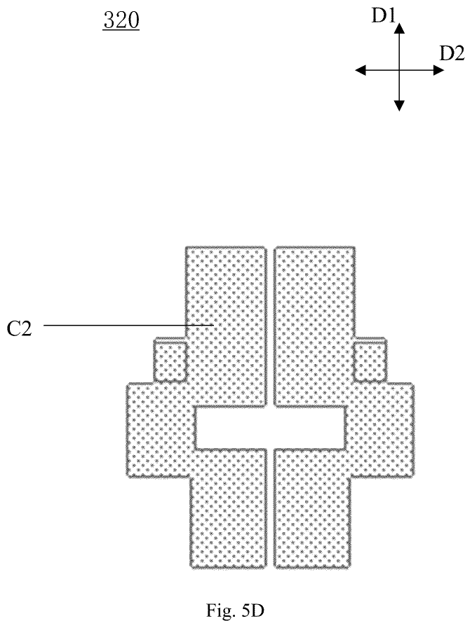

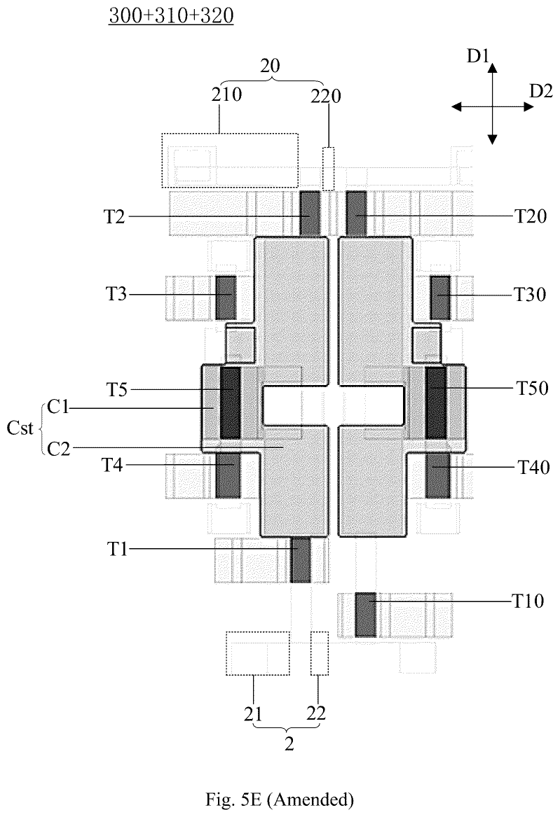

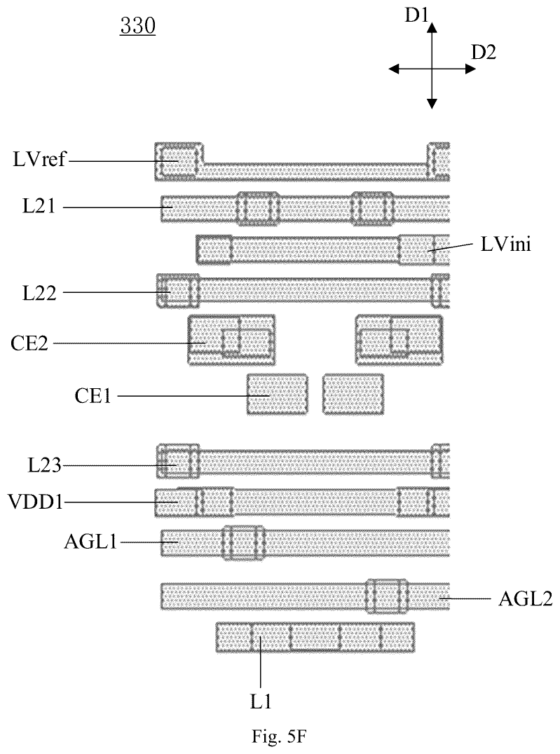

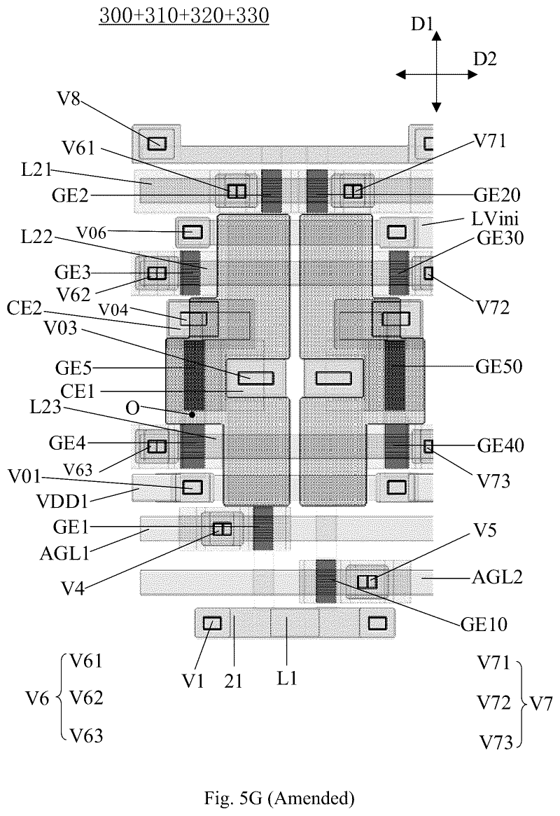

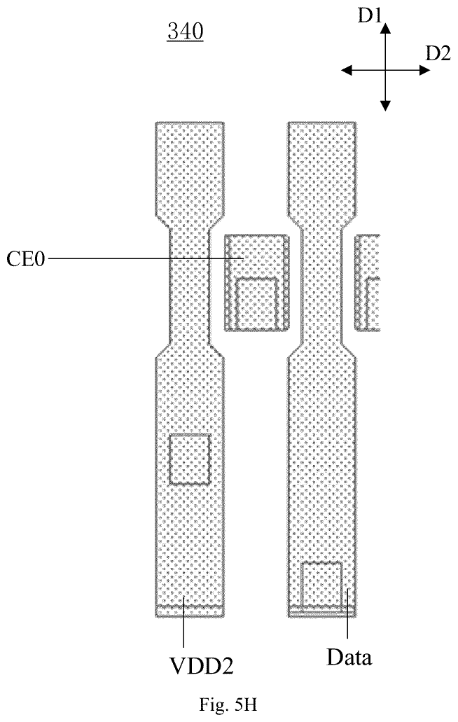

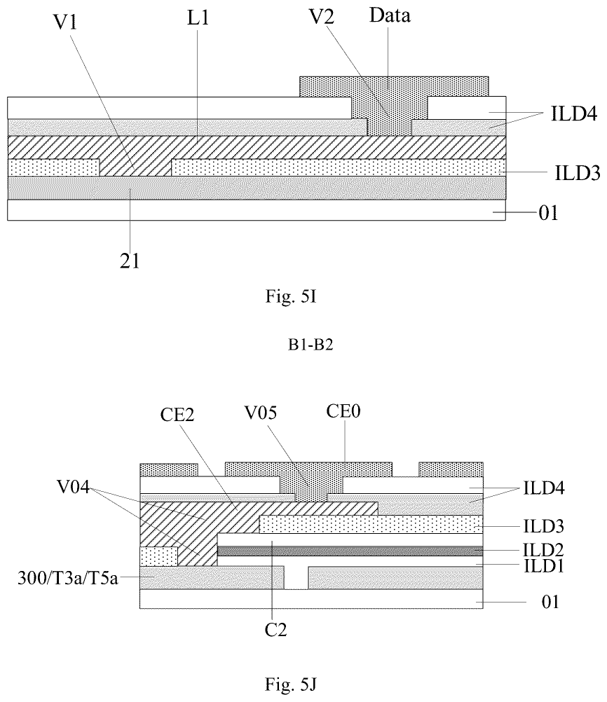

Exemplarily, FIG. 4 is a schematic layout diagram of the pixel circuit illustrated in FIG. 2; FIG. 5A to FIG. 5H respectively illustrates structural planar views of each layer of the pixel circuit illustrated in FIG. 4. FIG. 4 illustrates a pixel circuit layout schematic diagram of the pixel circuit illustrated in FIG. 2. FIG. 5A is a planar view of a semiconductor layer 300 of the display substrate provided by at least one embodiment of the present disclosure, FIG. 5B is a planar view of a first conductive layer 310 of the display substrate provided by at least one embodiment of the present disclosure, FIG. 5C is a schematic diagram of a stacking of the semiconductor layer 300 and the first conductive layer 310, FIG. 5D is a planar view of a second conductive layer 320 of the display substrate provided by at least one embodiment of the present disclosure, FIG. 5E is a schematic diagram of a stacking of the semiconductor layer 300, the first conductive layer 310 and the second conductive layer 320, FIG. 5F is a planar view of a third conductive layer 330 of the display substrate provided by at least one embodiment of the present disclosure, FIG. 5G is a diagram of a stacking of the semiconductor layer 300, the first conductive layer 310, the second conductive layer 320 and the third conductive layer 330, FIG. 5H is a planar view of a fourth conductive layer 340 of the display substrate provided by at least one embodiment of the present disclosure.

For example, referring to FIG. 5A to FIG. 5H and FIG. 5J introduced in detail later, the display substrate further includes a first insulating layer ILD1, a second insulating layer ILD2, a third insulating layer ILD3 and a fourth insulating layer ILD4; the first insulating layer ILD12 is located between the semiconductor layer 300 and the first conductive layer 310, the second insulating layer ILD2 is located between the first conductive layer 310 and the second conductive layer 320, the third insulating layer ILD3 is located between the second conductive layer 320 and the third conductive layer 330, and the fourth insulating layer ILD4 is located between the third conductive layer 330 and the fourth conductive layer 340.

For example, the display substrate includes a base substrate, and the pixel circuit is provided on the main surface of the base substrate. For example, on the main surface of the base substrate and in a direction from a position close to the base substrate to a position away from the base substrate, the semiconductor layer 300, the first conductive layer 310, the second conductive layer 320, the third conductive layer 330 and the fourth conductive layer 340 are arranged in sequence, that is, the first conductive layer 310 is located on the side of the semiconductor layer 300 away from the base substrate, the second conductive layer 320 is located on the side of the first conductive layer 310 away from the base substrate, the third conductive layer 330 is located on the side of the second conductive layer 320 away from the base substrate, and the fourth conductive layer 340 is located on the side of the third conductive layer 330 away from the base substrate. Of course, a display substrate provided in other embodiments may include a part of conductive layers of the first conductive layer 310, the second conductive layer 320, the third conductive layer 330 and the fourth conductive layer 340, and these four conductive layers are not must be arranged in every display substrate provided by the embodiments.

For example, FIG. 4 illustrates two adjacent sub-pixels, that is a first sub-pixel P1 and a second sub-pixel P2. For example, referring to FIG. 1, both of the first sub-pixel P1 and the second sub-pixel P2 that are adjacent to each other can emit red light to form a red light-emitting unit R, both of the first sub-pixel P1 and the second sub-pixel P2 that are adjacent to each other can emit green light to form a green light-emitting unit G, and both of the first sub-pixel P1 and the second sub-pixel P2 that are adjacent to each other can emit blue light to form a blue light-emitting unit B. For example, the display substrate 10 includes a red pixel row including a plurality of red light-emitting units R, a green pixel row including a plurality of green light-emitting units G, and a blue pixel row including a plurality of blue light-emitting units B, the red pixel row, the green pixel row and the blue pixel row are arranged sequentially in the first direction D1 and all extend in the second direction D2. One red pixel row, one green pixel row and one blue pixel row continuously distributed constitute a repeating unit, for example, the display substrate 10 includes a plurality of repeating units.

The structure of a sub-pixel is introduced by taking a first sub-pixel P1 as an example, for example, each sub-pixel may include a structure that performs the following functions of the first sub-pixel P1.

For example, referring to FIG. 5A, an active layer of each of the transistors of the first sub-pixel P1 and an active layer of each of the transistors of the second sub-pixel P2 are located in the semiconductor layer 300, the active layers of the transistors of the first sub-pixel P1 include their respective channel regions A1 to A5, and the active layer of the transistors of the second sub-pixel P2 include their respective channel regions A10 to A50; referring to FIG. 5B, the gate electrodes GE1 to GE5 and the first capacitive electrode C1 of the storage capacitor Cst of the transistors of the first sub-pixel P1 are located in the first conductive layer 310, of course, the first conductive layer 310 also includes the gate electrodes GE10 to GE50 of the transistors of the second sub-pixel P2; referring to FIG. 5D, for each sub-pixel, taking the first sub-pixel P1 as an example, the second capacitive electrode C2 of the storage capacitor Cst is located in the second conductive layer 320; referring to FIG. 5F, a compensation signal line LVref, a lateral power supply line VDD1, a first auxiliary gate line AGL1, a second auxiliary gate line AGL2 and each of connection electrodes are located in the third conductive layer 330; referring to FIG. 5H, a longitudinal power supply line VDD2 and a data signal line Data are located in the fourth conductive layer 340.

In the display panel provided by at least one embodiment of the present disclosure, a connection position of a first electrode of a control transistor and an active layer of the control transistor is a first position, and a connection position of a second electrode of the control transistor and the active layer of the control transistor is a second position, a connection position of the first electrode of the driving transistor and the active layer of the driving transistor is a third position, and a distance between the first position and the second position is greater than a distance between the first position and the third position.

For example, the pixel circuit of the first sub-pixel P1 includes a control sub-circuit, the control sub-circuit includes the control transistor, and the first electrode of the control transistor is electrically connected to the gate electrode GE5 of the driving transistor T5. For example, the control sub-circuit may include the data writing sub-circuit 40, that is, the data writing sub-circuit 40 serves as an example of the control sub-circuit, and the control transistor includes the data writing transistor T1. The structure of the data writing transistor T1 is introduced below by taking the case where the control transistor includes the data writing transistor T1 as an example.

Of course, the pixel circuit illustrated in FIG. 2 and FIG. 4 are 5T1C circuit, in other embodiments, the pixel circuit can further be the other type of pixel circuit and is not limited to the 5T1C circuit.

Referring to FIG. 5A and FIG. 5G, the connection position of the first electrode of the data writing transistor T1 and the active layer of the first electrode of the data writing transistor T1 is a first sub-position, and the connection position of the second electrode of the data writing transistor T1 and the active layer of the writing transistor T1 is a second position, that is, in the case where the data writing transistor T1 serves as the control transistor, the first sub-position serves as the above-mentioned first position, and the second sub-position serves as the above-mentioned second position. The connection position of the first electrode of the driving transistor T5 and the active layer of the driving transistor T5 is the third position, and the distance between the first sub-position and the second sub-position is greater than the distance between the first sub-position and the third position, so that a length of the active layer of the data writing transistor T1 and the distance between the source electrode and the drain electrode of the data writing transistor T1 can be increased, thereby increasing the equivalent resistance of the data writing transistor T1 and reducing the leakage current of the writing transistor T1, therefore, the risk of leaking current of the first node G through the writing transistor T1 when the writing transistor T1 is in the turned-off state is reduced, the potential changing (undeserved fluctuation) of the gate electrode of the driving transistor T5 (the first node G) resulted by the leaking current can be reduced, and the above-mentioned screen flickering phenomenon on the display panel can be reduced or eliminated.

For example, the material of the semiconductor layer 300 is low-temperature poly-silicon (LTPS). For example, the active layers of a plurality of transistors in one sub-pixel P constitute an integral structure. In this case, the plurality of transistors in one sub-pixel P are LTPS transistors, because the mobility of the low-temperature poly-silicon active layer is high, the leakage current of the corresponding transistors is large, in this case, because the above-mentioned problem of potential changing (undeserved fluctuation) of the first node G caused by the leakage current of the transistor electrically connected to the node G is particularly serious, the effect of improving this problem of the display substrate provided by the embodiment of the present disclosure is particularly significant.

Of course, the material of the semiconductor layer 300 provided in other embodiments of the present disclosure is not limited to the low-temperature poly-silicon, and may be an oxide semiconductor material such as indium gallium zinc oxide (IGZO), or other semiconductor materials, in the case where the material of the semiconductor layer 300 is not the low-temperature poly-silicon, the above-mentioned problem of potential changing (undeserved fluctuation) of the first node G caused by the leakage current of the transistor electrically connected to the first node G still exists, similarly, the display substrates provided by the embodiments of the present disclosure can also play a role in reducing this problem.

For example, a linear distance between the first sub-position and the second sub-position is greater than a linear distance between the first sub-position and the third position; or, a distance between the first sub-position and the second sub-position in the first direction D1 is greater than a distance between the first sub-position and the third position in the first direction D1, for example, in each embodiment of the present disclosure, for the data writing transistor T1, the distance between the first sub-position and the second sub-position is greater than 0.5 times, 0.7 times or 0.8 times a width of one sub-pixel, so as to make full use of the limited sub-pixel space to achieve a sufficient distance between the source electrode and the drain electrode of the data writing transistor T1, and achieve an ideal effect of reducing the leakage current of the data writing transistor T1; for example, the distance between the first sub-position and the second sub-position in the first direction D1 is greater than 0.5 times, 0.7 times or 0.8 times a width of one sub-pixel in the first direction D1.

Alternatively, the sum of the distance between the first sub-position and the second sub-position in the first direction D1 and a distance between the first sub-position and the second sub-position in the second direction D2 is greater than the sum of the distance between the first sub-position and the third position in the first direction D1 and a distance between the first sub-position and the third position in the second direction D2.

For example, referring to FIG. 4 and FIG. 5F to FIG. 5G, the first capacitive electrode C1 of the storage capacitor Cst and the gate electrode of the driving transistor T5 constitute an integral structure, the sub-pixel P1 includes a first connection block CE1, for example, the first connection block CE1 is located in the third conductive layer 330; the first connection block CE1 is electrically connected to the gate electrode of the driving transistor T5 through a first connection via hole V03, that is, electrically connected to the first capacitive electrode C1 of the storage capacitor Cst; a part of the first connection via hole V03 exposes a part of the semiconductor layer 300, because the active layers of the transistors of the pixel circuit constitute an integral structure, a part of the first connection via hole V03 exposes a part of the active layer of the data writing transistor T1, the first connection block CE1 is electrically connected to the active layer of the data writing transistor T1 through the first connection via hole V03, referring to FIG. 5A, because the active layer of the data writing transistor T1 and the active layer of the driving transistor T5 form a continuous integrated structure, the first connection block CE1 is further electrically connected to the active layer of the driving transistor T5 through the first connection via hole V03. Therefore, the first connection block CE1 serves as the first electrode of the data writing transistor T1, and realizes that the first capacitive electrode C1 of the storage capacitor Cst, the gate electrode GE5 of the driving transistor T5 and the first electrode of the data writing transistor T1 are electrically connected to the first node G, the position of the first connection via hole V03 is the above-mentioned first sub-position.

For example, the second electrode of the data writing transistor T1 is electrically connected to the active layer of the data writing transistor T1 through a second connection via hole, and the position of the second connection via hole is the second sub-position.

Exemplarily, referring to FIG. 5F and FIG. 5G, the pixel circuit includes a first connection electrode L1 arranged in a layer different from both the active layer of the driving transistor T5 and the data signal line Data, for example, the first connection electrode L1 is located in the third conductive layer 330. FIG. 5I is a schematic cross-sectional view along the line A1-A2 in FIG. 4, referring to FIG. 4, FIG. 5F to FIG. 5G and FIG. 5I, a first extension portion 21 of a lateral portion 2 is electrically connected to the first connection electrode L1 through a first via hole V1, the first connection electrode L1 is electrically connected to the data signal line Data through a second via hole V2, thereby realizing the electrical connection between the data signal line Data and the active layer of the data writing transistor T1. In this case, the first via hole V1 serves as the above-mentioned second connection via hole, and therefore, the position of the first via hole V1 is the above-mentioned second sub-position. On the one hand, the connection between the data signal line Data and the active layer of the data writing transistor T1 is realized through two via holes, that is, the first via hole V1 and the second via hole V2 which are arranged in a direction perpendicular to the main surface of the base substrate, the reliability of the electrical connection can be ensured, on the other hand, the first extension portion 21 whose length is increased is electrically connected to the data signal line Data through the first via hole V1 and the first connection electrode L1, which is beneficial to increasing an effective length of the active layer of the data writing transistor T1.

It should be noted that the effective length of the active layer of the data writing transistor T1 refers to a length of a portion of the active layer of the data writing transistor T1 that actually participates in conduction when the data writing transistor T1 generates the leakage current.

For example, the first via hole V1 is located at an end portion of the first extension portion 21 away from the longitudinal portion 1 in the second direction D2. In this way, the length of the first extension 21 can be used to maximize the effective length of the active layer of the data writing transistor T1, and the entire length of the first extension portion 21 can be basically used to increase the effective length of the active layer.

For example, referring to FIG. 5F and FIG. 5G, the pattern of the first connection electrode L1 is substantially the same as and coincident with the pattern of the lateral portion 2 of the active layer of the data writing transistor T1, that is, an orthographic projection of the first connection electrode L1 on the main surface of the base substrate substantially coincides with an orthographic projection of the lateral portion 2 of the active layer of the data writing transistor T1 on the main surface of the base substrate, so as to prevent the first connection electrode L1 from occupying additional space and reduce the volume of the pixel circuit, which is beneficial to improving the PPI of the display substrate FIG. 5J is a schematic cross-sectional view along line B1-B2 in FIG. 4. For example, referring to FIG. 4, FIG. 5F to FIG. 5G and FIG. 5J, a second connection block CE2 located in the third conductive layer 330 is electrically connected to the second capacitive electrode C2 of the storage capacitor Cst through a third connection via hole V04, for example, an upper portion of the third connection via hole V04 exposes a part of the second capacitive electrode C2 of the storage capacitor Cst, and the second connection block CE2 contacts and is electrically connected to the second capacitive electrode C2 of the storage capacitor Cst through the upper portion of the third connection via hole V04. Because the active layer of the driving transistor T5 and the active layer of the second reset transistor T3 constitute a continuous integrated structure, a lower portion of the third connection via hole V04 exposes the active layer T3a of the driving transistor T5, that is, exposes the active layer T3a of the second reset transistor T3, the lower portion of the third connection via hole V04 communicates with the upper portion of the third connection via hole V04, and the lower portion of the third connection via hole V04 is located on the side of the upper portion of the third connection via hole V04 close to the base substrate 01, so that the second connection block CE2 is electrically connected to the active layer T5a of the driving transistor T5 through the lower portion of the third connection through hole V04, and also electrically connected to the active layer T3a of the second reset transistor T3 (that is, electrically connected to the semiconductor layer 300), therefore, the position of the third connection via hole V04 is the above-mentioned third position, and the second connection block CE2 serves as the first electrode of the second reset transistor T3 and the first electrode of the driving transistor T5, so that the first electrode of the second reset transistor T3, the first electrode of the driving transistor T5 and the second capacitive electrode C2 of the storage capacitor Cst are electrically connected to the second node S; and, the second connection block CE2 is electrically connected to a third connection block CE0 in the fourth conductive layer 340 through a via hole V05, the third connection block CEO can be further electrically connected to the first electrode (not illustrated) of the light-emitting element EL stacked on the side of the fourth conductive layer 340 away from the base substrate 01, thereby realizing that the second node S is electrically connected to the first electrode of the light-emitting element EL.

Referring to FIG. 4 and FIG. 5A, for example, the channel region A5 of the driving transistor T5 and the channel region A1 of the data writing transistor T1 are arranged in the first direction D1, and a second direction D2 intersects with the first direction D1, for example, the second direction D2 is perpendicular to the first direction D1. Referring to FIG. 5A, the active layer of the data writing transistor T1 includes the longitudinal portion 1 extending in the first direction D1 and the lateral portion 2 extending in the second direction D2, the longitudinal portion 1 includes the channel region A1 of the data writing transistor T1, that is, the longitudinal portion 1 includes the channel region of the control transistor. The lateral portion 2 is connected to the longitudinal portion 1, the lateral portion 2 includes the first extension portion 21 and a second extension portion 22, the first extension portion 21 protrudes from the longitudinal portion 1 towards a first side in the second direction D2, the second extension portion 22 protrudes from the longitudinal portion 1 towards a second side opposite to the first side in the second direction D2. In this way, the length of the active layer of the data writing transistor T1 is increased, the distance between the drain electrode and the source electrode of the data writing transistor T1 is increased, thereby increasing the equivalent resistance of the data writing transistor T1, and reducing the leakage current of the data writing transistor T1, therefore, the risk of leaking current of the first node G through the data writing transistor T1 when the data writing transistor T1 is in the turned-off state, the potential changing of the gate electrode of the driving transistor T5 (the node G) resulted by the leaking current can be reduced, and the above-mentioned screen flickering phenomenon on the display panel can be reduced or eliminated.

It should be noted that “channel region of a transistor” in the present disclosure refers to a region of an active layer of the transistor and a gate electrode of the transistor that overlap each other in a direction perpendicular to the main surface of the base substrate, that is, the region where an orthographic projection of the active layer of the transistor on the main surface of the base substrate overlaps with an orthographic projection of the gate electrode on the main surface of the base substrate corresponds to the channel region of the transistor.

For example, referring to FIG. 5A, the channel region A5 of the driving transistor T5 is located on the first side of the longitudinal portion 1 in the second direction D2, and the length of the first extension portion 21 in the second direction D2 is not less than the length of the second extension portion 22 in the second direction D2, therefore, the space on the first side of the longitudinal portion 1 in the second direction D2 can be fully utilized to extend the length of the active layer of the data writing transistor T1, thereby increasing the length of the distance between the source electrode of the data writing transistor T1 and the drain electrode of the data writing transistor T1, so as to utilize the limited space as much as possible to reduce the leakage current of the data writing transistor T1, thereby reducing the risk of leaking current of the first node G through the data writing transistor T1. For example, the length of the first extension portion 21 in the second direction D2 is not greater than the length of the second extension portion 22 in the second direction D2, or, the length of the first extension portion 21 in the second direction D2 is substantially equal to the length of the second extension portion 22 in the second direction D2.

For example, referring to FIG. 5A, the longitudinal portion 1 has a distal end away from the channel region A5 of the driving transistor T5 in the first direction D1, and the first extension portion 21 and the second extension portion 22 are located at the distal end of the longitudinal portion 1 and are connected to the distal end of the longitudinal portion 1. In this way, the longitudinal portion 1 extending in the first direction D1 can be used to form the channel region A1 of the data writing transistor T1, and the lateral portion 2 can further be arranged in the space created on both sides of the distal end of the longitudinal portion 1 in the second direction D2, the space can be reasonably utilized to realize the structure of the data writing transistor T1 and increase the length of the active layer of the data writing transistor T1 to increase the equivalent resistance of the data writing transistor T1.

For example, referring to FIG. 5A, the first extension portion 21 of the active layer of the data writing transistor T1 at least partially overlaps with the channel region A5 of the driving transistor T5 in the first direction D1. Therefore, the space in the second direction D2 is utilized to appropriately increase the length of the first extension portion 21, and in the second direction D2, the first extension portion 21 extends at least to the position where the channel region A5 of the driving transistor T5 is located, which can not only make the leakage current of the data writing transistor T1 reach an appropriate value and achieve the effect of fully reducing the leakage current of the data writing transistor T1, but also do not occupy the arrangement space of other structures of the pixel circuit, thus the normal function of the pixel circuit can be ensured to ensure display quality.

For example, referring to FIG. 4 and FIG. 5H, the display substrate includes the data signal line Data that provides the data signal Vd, and the lateral portion 2 of the active layer of the data writing transistor T1 is electrically connected to the data signal line Data; for example, the data signal line Data provides the data signal Vd to both the first sub-pixel P1 and the second sub-pixel P2, that is, the first sub-pixel P1 and the second sub-pixel P2 share one data signal line Data. For example, in FIG. 1, the display substrate includes the first data signal line Data1, the second data signal line Data2, . . . , the (N−1)th data signal line Data(N−1) and the Nth data signal line DataN, N is a positive integer greater than 1. The display substrate 10 includes a plurality of sub-pixels P arranged in the second direction D2, the plurality of sub-pixels are numbered starting from 1 along the first direction, so that the plurality of sub-pixels include odd-numbered sub-pixels and even-numbered sub-pixels, and every adjacent two sub-pixels that are respectively an odd-numbered sub-pixel and an even-numbered sub-pixel share one data signal line.

For example, the first sub-pixel P and the second sub-pixel P are arranged and adjacent in the second direction D2; the gate electrode GE1 of the data writing transistor T1 of the first sub-pixel P and the gate electrode GE1 of the data writing transistor T1 of the second sub-pixel P are independent of each other to receive different data writing control signals G1 respectively.

For example, referring to FIG. 4, FIG. 5F and FIG. 5G, the display substrate 10 includes a first auxiliary gate line AGL1 arranged in a layer different from the gate electrode GE1 of the data writing transistor T1 of the first sub-pixel P, for example, the first auxiliary gate line AGL1 is located in the third conductive layer 330, the first auxiliary gate line AGL1 is electrically connected to the gate electrode GE1 of the data writing transistor T1 of the first sub-pixel P through a fourth via hole V4. The display substrate 10 includes a second auxiliary gate line AGL2 arranged in a layer different from the gate electrode GE1 of the data writing transistor T1 of the second sub-pixel P, for example, the second auxiliary gate line AGL2 is also located in the third conductive layer 330, and the second auxiliary gate line AGL2 is electrically connected to the gate electrode GE1 of the data writing transistor T1 of the second sub-pixel P through a fifth via hole V5. The display substrate 10 includes a plurality of sub-pixels P arranged in the second direction D2, the plurality of sub-pixels are numbered starting from 1 along the first direction, so that the plurality of sub-pixels include odd-numbered sub-pixels and even-numbered sub-pixels. For example, the first auxiliary gate line AGL1 is electrically connected to a plurality of odd-numbered sub-pixels through a plurality of fourth via holes V4 respectively, and the second auxiliary gate line AGL2 is electrically connected to a plurality of even-numbered sub-pixels through a plurality of sixth via holes V6 respectively.

For example, the first extension portion 21 of the active layer of the data writing transistor T1 at least partially overlaps with fourth via hole V4 in the first direction D1. Therefore, the space in the second direction D2 is utilized to appropriately increase the length of the first extension portion 21, in the second direction D2, the first extension portion 21 extends at least to the position where the fourth via hole V4 is located, which can not only make the leakage current of the data writing transistor T1 reach an appropriate value and achieve the effect of fully reducing the leakage current of the data writing transistor T1, but also do not occupy the arrangement space of other structures of the pixel circuit, the normal function of the pixel circuit can be ensured to ensure display quality.

For example, a gate electrode of a common-gate transistor of the first sub-pixel P and a gate electrode of a common-gate transistor of the second sub-pixel P are electrically connected to each other to share a same data writing control signal G1, for example, the common-gate transistor includes at least one of the transistors in the pixel circuit other than the data writing transistor T1 and the driving transistor T5; for example, in the pixel circuit illustrated in FIG. 4, the transistors other than the data writing transistor T1 and the driving transistor T5 share the same gate line and thus the same gate scan signal. Of course, it is not limited to this situation in other embodiments.

For example, referring to FIG. 5F and FIG. 5G, the display substrate 10 includes a second connection electrode arranged in a layer different from the gate electrode of the common-gate transistor, the second connection electrode is electrically connected to the gate electrode of the common-gate transistor of the first sub-pixel P1 through a sixth via hole V6 and is electrically connected to the gate electrode of the common-gate transistor of the second sub-pixel P2 through a seventh via hole V7. Therefore, the gate electrodes of the common-gate transistors are electrically connected to each other through the second connection electrode to realize the sharing of the gate scan signal. For example, the second connection electrode includes a first sub-electrode L21, a second sub-electrode L22, a third sub-electrode L23, and a fourth sub-electrode L24, and the sixth via hole V6 includes a sub-via hole V61, a sub-via hole V62, a sub-via hole V63 and a sub-via hole V64, the seventh via hole V7 includes a sub-via hole V71, a sub-via hole V72, a sub-via hole V73 and a sub-via hole V74; the first sub-electrode L21 is electrically connected to the gate electrode GE2 of the reset transistor T2 of the first sub-pixel P1 through the sub-via hole V61 and is electrically connected to the gate electrode GE20 of the first reset transistor T20 of the second sub-pixel P2 through the sub-via hole V71, the second sub-electrode L22 is connected to the gate electrode GE3 of the second reset transistor T3 of the first sub-pixel P1 through the sub-via hole V62 and is electrically connected to the gate electrode GE30 of the second reset transistor T30 of the second sub-pixel P2 through the sub-via hole V72, and the third sub-electrode L23 is connected to the gate electrode GE4 of the light-emitting control transistor T4 of the sub-pixel P1 through the sub-via hole V63 and is electrically connected to the gate electrode GE40 of the light light-emitting control transistor T40 of the second sub-pixel P2 through the sub-via hole V73.

In this way, referring to FIG. 5F, the first auxiliary gate line AGL1 and the second connection electrode are both arranged in the same layer as the first connection electrode L1, for example, both are located in the third conductive layer 330. In this way, the sufficient space of the third conductive layer 330 can be utilized to lay out these conductive structures, which is conducive to reducing the occupied space of the pixel circuit of each sub-pixel, thereby improving the PPI of the display substrate 10 and achieving high resolution.

For example, the above-mentioned control transistor further includes a first reset transistor T2. The connection position of the first electrode of the first reset transistor T2 and the active layer of the first reset transistor T2 is a third sub-position, and the connection position of the second electrode of the first reset transistor T2 and the active layer of the first reset transistor T2 is a fourth sub-position; the distance between the first sub-position and the second sub-position is greater than the distance between the third sub-position and the fourth sub-position. In this way, compared to the first reset transistor T2, the length of the active layer of the data writing transistor T1 is increased to a greater extent, so that the distance between the drain electrode of the data writing transistor T1 and the source electrode of the data writing transistor T1 is increased to a greater extent, thereby increasing the equivalent resistance of the data writing transistor T1. Because the compensation signal or the first reset signal Vref (a reference voltage) transmitted to the first node G through the first reset transistor T2 is basically a constant voltage, and the data voltage Vd transmitted to the first node G through the data writing transistor T1 is a voltage that changes in real time, therefore, the leakage current of the data writing transistor T1 will have a greater impact on the stability of the potential of the first node G, thereby increasing the length of the active layer of the data writing transistor T1 to a greater extent is conducive to better maintaining the stability of the potential of the first node G in the light-emitting phase, and is more conducive to improving the display quality.

For example, referring to FIG. 5F, the display substrate 10 includes a compensation signal line LVref that provides the compensation signal Vref, the first extension portion 210 of the lateral portion 20 of the active layer of the first reset transistor T2 is electrically connected to the compensation signal line through an eighth via hole V8. For example, an end portion of the first extension portion 210 away from the longitudinal portion 11 of the active layer of the first reset transistor T2 in the second direction D2 is electrically connected to the compensation signal line L Vref through the eighth via hole V8. A position of the eighth via hole V8 serves as the second position in the case where the control transistor is the first reset transistor T2, that is, as the fourth sub-position.

For example, at least a part of the pattern shape of the compensation signal line LVref is the same as and overlaps with the pattern shape of the first extension portion 21 of the active layer of the first reset transistor T2, so as to fully save space and reduce the difficulty of fabricating masks for the pattern to from the compensation signal line LVref and the pattern to from the first extension portion 21 of the active layer of the first reset transistor T2 in the patterning process.

The active layer of the data writing transistor T1 extends from the first sub-position to the second sub-position, the active layer of the first reset transistor T2 extends from the third sub-position to the fourth sub-position, and the total length of the active layer of the data writing transistor T1 from the first sub-position to the second sub-position is greater than the total length of the active layer of the first reset transistor T2 from the third sub-position to the fourth sub-position. Similarly, compared with the first reset transistor T2, the length of the active layer of the data writing transistor T1 is increased to a greater extent, so that the distance between the drain electrode and the source electrode of the data writing transistor T1 is increased to a greater extent, thereby increasing the equivalent resistance of the data writing transistor T1, which is conducive to better maintaining the stability of the potential of the first node G in the light-emitting phase, and is more conducive to improving the display quality.

For example, referring to FIG. 4 and FIG. 5G, the connection position of the first electrode of the second reset transistor T3 and the active layer of the second reset transistor is a seventh sub-position; the connection position of the second electrode of the second reset transistor T3 and the active layer of the second reset transistor T3 is an eighth sub-position; the connection position of the first electrode of the light-emitting control transistor T4 and the active layer of the light-emitting control transistor T4 is a ninth sub-position, and the connection position of the second electrode of the light-emitting control transistor T4 and the active layer of the light-emitting control transistor T4 a tenth sub-position.

For example, referring to FIG. 5F and FIG. 5G, the display substrate 10 further includes a lateral power supply line VDD1, which is electrically connected to the first power supply voltage terminal; for example, the lateral power supply line VDD1 is located in the third conductive layer 330, and the lateral supply power supply line VDD1 is electrically connected to the active layer of the light-emitting control transistor T4 through a via hole V01 so that the first electrode of the light-emitting control transistor T4 is electrically connected to the lateral power supply line VDD1 to receive the first power supply voltage VDD. Referring to FIG. 5H and FIG. 4, the display substrate 10 further includes a longitudinal power supply line VDD2, for example, the longitudinal power supply line VDD2 is located in the fourth conductive layer 340, the longitudinal power supply line VDD2 is electrically connected to the lateral power supply line VDD1 through a via hole V02, so that a network constituted by the horizontal supply line and the vertical power supply line can be formed in the display substrate 10, and the first power supply voltage VDD is transmitted to each sub-pixel.

For example, referring to FIG. 5F and FIG. 5G, the display substrate 10 further includes an initial signal line LVini, for example, the initial signal line LVini is located in the third conductive layer 330, and the initial signal line LVini is electrically connected to the active layer of the second reset transistor T3 through a via hole V06 to provide the second reset signal.

Here, the position of the third connection via hole V04 severs as the seventh sub-position, the position of the via hole V06 severs as the eighth sub-position, and the position of the via hole V01 severs as the ninth sub-position; the active layer of the driving transistor T5 and the active layer of the light-emitting control transistor T4 constitute an integral structure, the second electrode of the driving transistor T5 is electrically connected to the second electrode of the light-emitting control transistor T4, and the position O severs as the tenth sub-position.

For example, the distance between the first sub-position and the second sub-position is greater than the distance between the seventh sub-position and the eighth sub-position, and/or, the distance between the first sub-position and the second sub-position is greater than the distance between the ninth sub-position and the tenth sub-position; or, the distance between the fifth sub-position and the sixth sub-position is greater than the distance between the seventh sub-position and the eighth sub-position, and/or, the distance between the fifth sub-position and the sixth sub-position is greater than the distance between the ninth sub-position and the tenth sub-position.

For example, the distance between the above two positions refers to the linear distance between the two positions, or, the distance between the two positions in the first direction D1, or the sum of the distance between the two positions in the first direction D1 and the distance between the two positions in the second direction D2.

The active layer of the second reset transistor T3 extends from the seventh sub-position to the eighth sub-position, and the active layer of the light-emitting control transistor T4 extends from the ninth sub-position to the tenth sub-position; the total length of the active layer of the data writing transistor T1 from the first sub-position to the second sub-position is greater than the total length of the active layer of the second reset transistor T3 from the seventh sub-position to the eighth sub-position, and/or, the total length of the active layer of the data writing transistor T1 from the first sub-position to the second sub-position is greater than the total length of the active layer of the light-emitting control transistor T4 from the ninth sub-position to the tenth sub-position.

Alternatively, the active layer of the first reset transistor T2 extends from the third sub-position to the fourth sub-position, and the total length of the active layer of the first reset transistor T2 from the third sub-position to the fourth sub-position is greater than the total length of the active layer of the second reset transistor T3 from the seventh sub-position to the eighth sub-position, and/or, a total length of the active layer of the first reset transistor T2 from the third sub-position to the fourth sub-position is greater than the total length of the active layer of the light-emitting control transistor T4 from the ninth sub-position to the tenth sub-position.

Referring to FIG. 4 and FIG. 5A, the active layer of the first reset transistor T2 includes the longitudinal portion 11 extending in the first direction D1 and the lateral portion 20 extending in the second direction D2, the longitudinal portion 11 includes the channel region A2 of the first reset transistor T2, that is, the longitudinal portion 11 includes the channel region of the control transistor. The lateral portion 20 is connected to the longitudinal portion 11, the lateral portion 20 includes the first extension portion 210 and the second extension portion 220, the first extension portion 210 protrudes from the longitudinal portion 11 toward the first side in the second direction D2, and the second extension portion 220 protrudes from the longitudinal portion 11 in the second direction D2 towards a second side opposite to the first side. In this way, the length of the active layer of the first reset transistor T2 is increased, and the distance between the drain electrode and the source electrode of the first reset transistor T2 is increased, thereby increasing the equivalent resistance of the first reset transistor T2, which can reduce the risk of leaking current of the first node G through the first reset transistor T2, reduce the potential changing of the gate electrode of the driving transistor T5 (the node G) resulted by the leaking current, and reduce or eliminate the above-mentioned screen flickering phenomenon on the display panel.

For example, referring to FIG. 5A, the channel region A5 of the driving transistor T5 is located on the first side of the longitudinal portion 11 in the second direction D2, and the length of the first extension portion 210 in the second direction D2 is not less than the length of the second extension portion 220 in the second direction D2, therefore, the space on the first side of the longitudinal portion 11 in the second direction D2 can be fully utilized to extend the length of the active layer of the data writing transistor T1, so as to utilize the limited space as much as possible to reduce the leakage current of the first reset transistor T2, and reduce the risk of leaking current of the first node G through the first reset transistor T2. For example, the length of the first extension portion 210 in the second direction D2 is not greater than the length of the second extension portion 220 in the second direction D2, or, the length of the first extension portion 210 in the second direction D2 is substantially equal to the length of the second extension portion 220 in the second direction D2.

For example, referring to FIG. 5A, the longitudinal portion 11 has a distal end away from the channel region A5 of the driving transistor T5 in the first direction D1, and the first extension portion 210 and the second extension portion 220 are located at the distal end of the longitudinal portion 11 and are connected to the distal end of the longitudinal portion 11. In this way, the longitudinal portion 11 extending in the first direction D1 can be used to form the channel region A2 of the first reset transistor T2, and the lateral portion 20 can further be arranged in the space created on both sides of the distal end in the second direction D2, the space can be reasonably utilized to realize the structure of first reset transistor T2 and increase the length of the active layer of the first reset transistor T2 to increase the equivalent resistance of the first reset transistor T2.

For example, referring to FIG. 5C, the first extension portion 210 of the active layer of the first reset transistor T2 at least partially overlaps with the channel region A5 of the driving transistor T5 in the first direction D1. Therefore, the space in the second direction D2 is utilized to appropriately increase the length of the first extension portion 210, in the second direction D2, the first extension portion 210 extends at least to the position where the channel region A5 of the driving transistor T5 is located, which can not only make the leakage current of the first reset transistor T2 reach an appropriate value and achieve the effect of fully reducing the leakage current of the first reset transistor T2, but also do not occupy the arrangement space of other structures of the pixel circuit, the normal function of the pixel circuit can be ensured to ensure display quality.

For example, referring to FIG. 5A and FIG. 5C, in the first direction D1, the channel region A5 of the driving transistor T5 is located between the channel region A1 of the data writing transistor T1 and the channel region A2 of the first reset transistor T2; in the first direction D1, the lateral portion 2 of the active layer of the data writing transistor T1 is located on a side of the channel region A1 of the data writing transistor T1 away from the channel region A5 of the driving transistor T5, that is, both of the first extension portion 21 and the second extension portion 22 of the active layer of the data writing transistor T1 are located on a side of the channel region A1 of the data writing transistor T1 away from the channel region A5 of the driving transistor T5; and, in the first direction D1, the lateral portion 20 of the active layer of the first reset transistor T2 is located on a side of the channel region A2 of the first reset transistor T2 away from the channel region A5 of the driving transistor T5, that is, both of the first extension portion 210 and the second extension portion 220 of the active layer of the first reset transistor T2 are located on a side of the channel region A2 of the first reset transistor T2 away from the channel region A5 of the driving transistor T5.

For example, the length of the first extension portion 210 of the active layer of the first reset transistor T2 in the second direction D2 is greater than or equal to the length of the first extension portion 21 of the active layer of the data writing transistor T1 in the second direction D2. The position of the first extension portion 210 of the active layer of the first reset transistor T2 is also used to arrange the compensation signal line LVref extending in the second direction D2, therefore, in the semiconductor layer 300, the space of the first extension portion 210 of the active layer of the first reset transistor T2 is relatively large, the length of the first extension portion 210 of the active layer of the first reset transistor T2 can be sufficiently increased to fully increase the length of the active layer of the first reset transistor T2, so that the limited space can be utilized as much as possible to reduce the leakage current of the first reset transistor T2, thereby effectively reducing the risk of leaking current of the first node G through the first reset transistor T2. Further, for example, the first extension portion 210 of the active layer of the first reset transistor T2 exceeds the active layer of the data writing transistor T1 in the second direction D2, similarly, the space where the first extension portion 210 of the active layer of the first reset transistor T2 is located is fully utilized to increase the length of the first extension portion 210 of the active layer of the first reset transistor T2, so that the limited space can be utilized as much as possible to reduce the leakage current of the first reset transistor T2, thereby effectively reducing the risk of leaking current of the first node G through the first reset transistor T2.

For example, referring to FIG. 4 and FIG. 5F to FIG. 5G, the first capacitive electrode C1 of the storage capacitor Cst and the gate electrode of the driving transistor T5 constitute an integral structure, and the first connection block CE1 located in the third conductive layer 330 is electrically connected to the first capacitive electrode C1 of the storage capacitor Cst through the via hole V03, and a part of the via hole V03 exposes a part of the semiconductor layer 300, because the active layers of the transistors of the pixel circuit constitute an integral structure, so a part of the via hole V03 exposes a part of the active layer of the data writing transistor T1, the first connection block CE1 is electrically connected to the active layer of the data writing transistor T1 through the via hole V03, therefore, the first connection block CE1 serves as the first electrode of the data writing transistor T1 to realize that the first capacitive electrode C1 of the storage capacitor Cst, the gate electrode of the driving transistor T5 and the first electrode of the data writing transistor T1 are electrically connected to the first node G.

FIG. 5J is a schematic cross-sectional view along the line B1-B2 in FIG. 4. For example, referring to FIG. 4, FIG. 5F to FIG. 5G and FIG. 5J, the second connection block CE2 located in the third conductive layer 330 is electrically connected to the second capacitive electrode C2 of the storage capacitor Cst through the via hole V04, and a part of the via hole V04 exposes the active layer of the second reset transistor T3, and then the second connection block CE2 is electrically connected to the active layer of the second reset transistor T3 through the via hole V04 (that is, electrically connected to the semiconductor layer 300), therefore, the second connection block CE2 serves as the first electrode of the second reset transistors T3 and the first electrode of the driving transistor T5 to realize that the first electrode of the second reset transistor T3, the first electrode of the driving transistor T5 and the second capacitive electrode C2 of the storage capacitor Cst are electrically connected to the second Node S; and, the second connection block CE2 is electrically connected to the third connection block CEO located in the fourth conductive layer 340 through the via hole V05, the third connection block CEO can further be electrically connected to the first electrode (not illustrated) of the light-emitting element EL stacked on a side of the fourth conductive layer 340 away from the substrate 01, thereby realizing the electrical connection between the second node S and the first electrode of the light-emitting element EL.

For example, referring to FIG. 4, for the first sub-pixel P1 and the second sub-pixel P2, except for the respective data writing transistor T1 and data writing transistor T10, other structures of the two are substantially symmetrical with respect to a symmetry axis extending in the first direction D1. For example, the pattern of the active layer of the data writing transistor T1 of the first subpixel P1 and the pattern of the active layer of the data writing transistor T10 of the second subpixel P2 are symmetrical with respect to the symmetry axis extending in the first direction D1, therefore, the active layer of the data writing transistor T10 of the second sub-pixel P2 further has a first extension portion 21a to increase the effective resistance of the data writing transistor T10 and reduce the leakage current of the data writing transistor T10. For example, referring to FIG. 5A, the pattern of the active layer of the first reset transistor T2 of the first sub-pixel P1 and the pattern of the active layer of the first reset transistor T20 of the second sub-pixel P2 are substantially symmetrical with respect to a symmetry axis extending in the first direction D1, so that the active layer of the first reset transistor T20 of the second sub-pixel P2 further has a first extension portion 210a to increase the effective resistance of the first reset transistor T20 and reduce the leakage current of the first reset transistor T20. In summary, for example, in any embodiment of the present disclosure, the design of the first extension portion of the data writing transistor T1 and/or the first extension portion of the first reset transistor may be applied to each sub-pixel P.

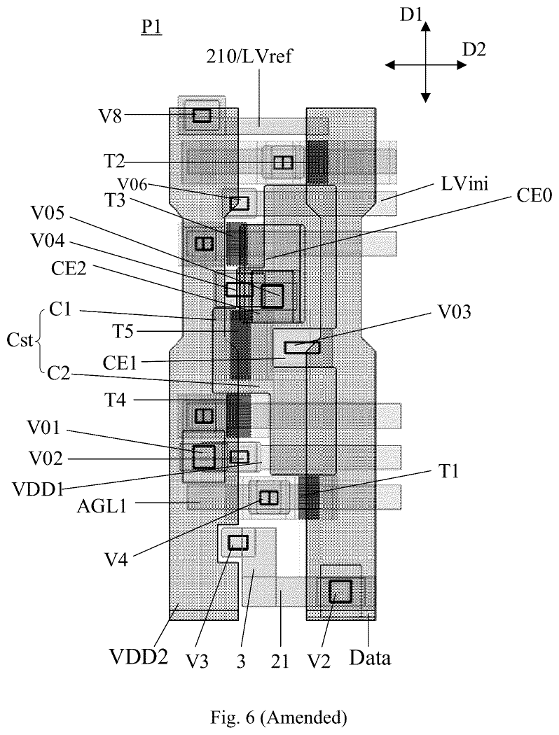

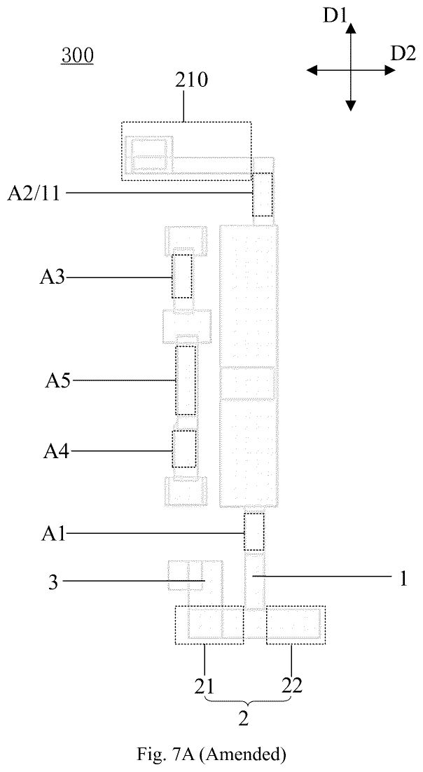

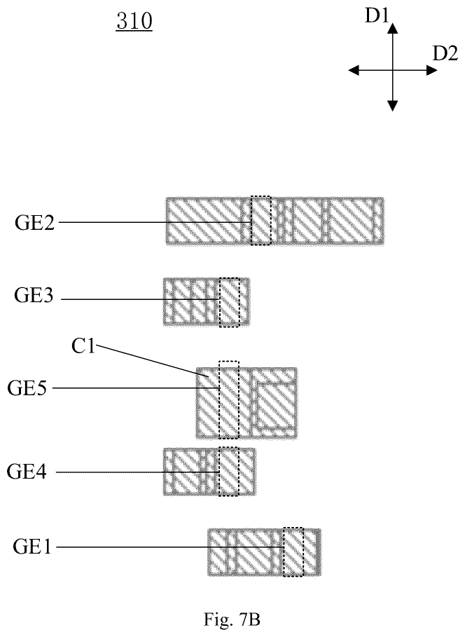

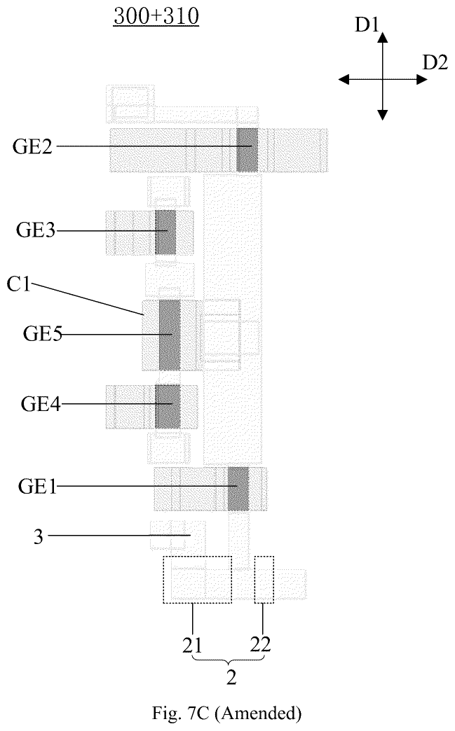

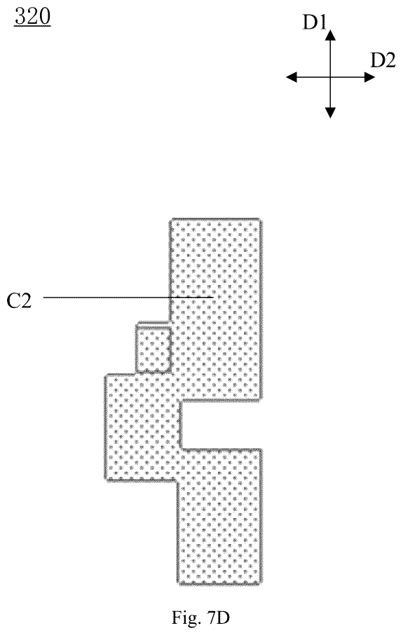

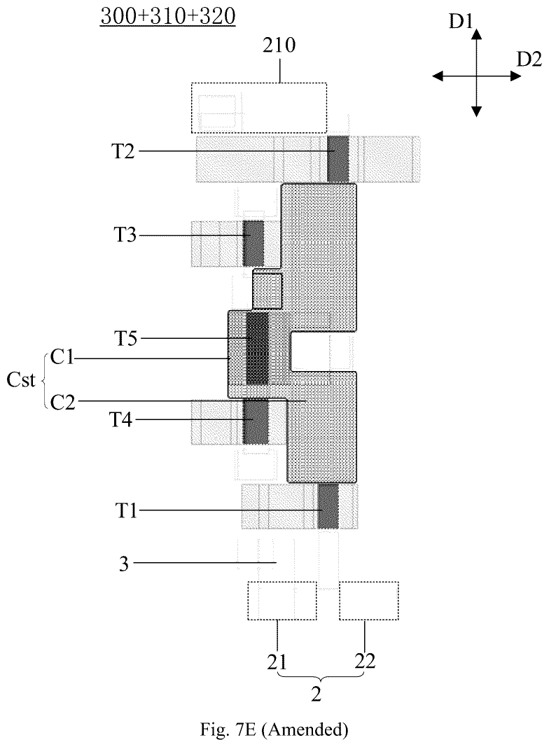

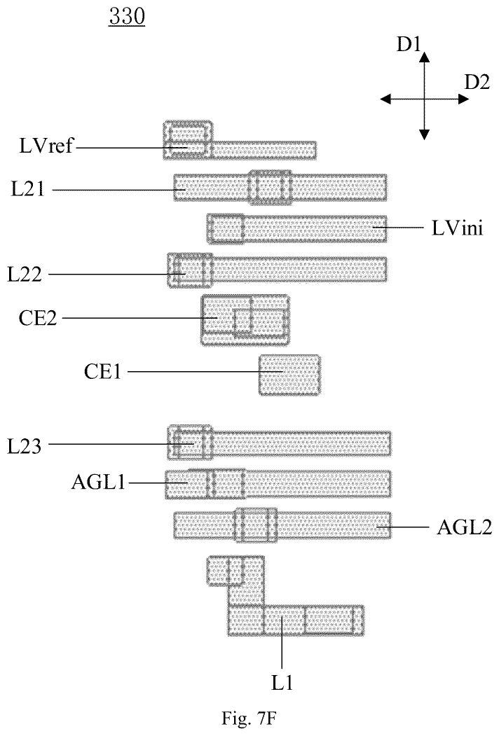

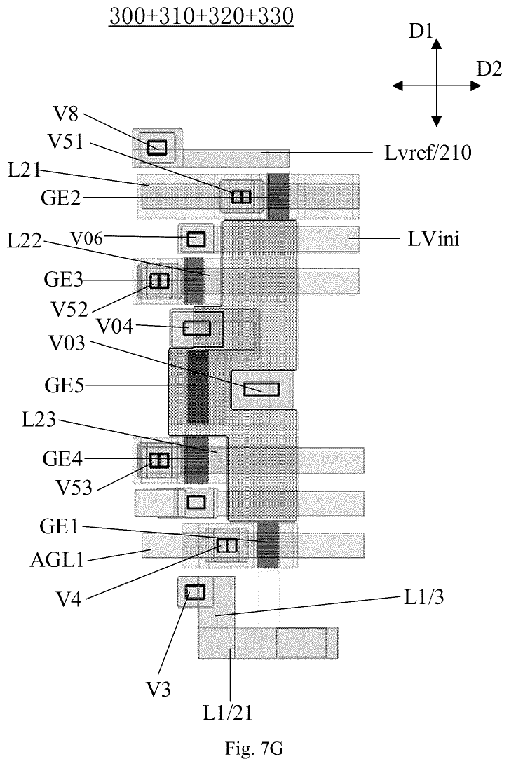

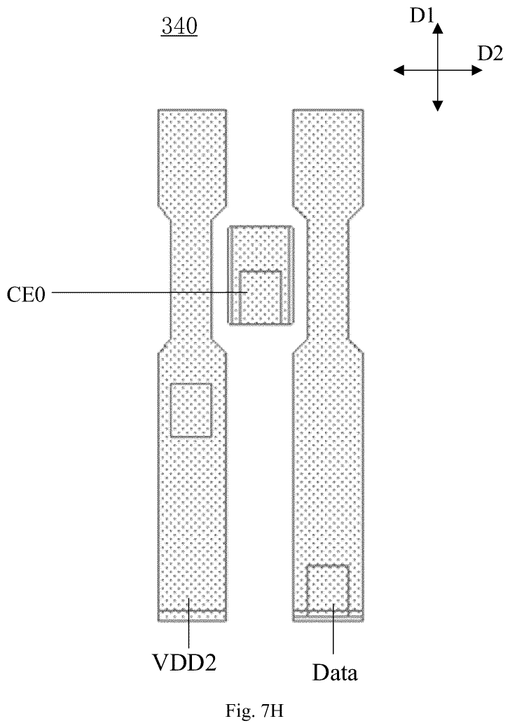

FIG. 6 is a schematic layout diagram of a pixel circuit of another display substrate provided by at least one embodiment of the present disclosure; FIG. 7A to FIG. 7H respectively illustrates a structural planar view of each layer of the pixel circuit illustrated in FIG. 6. In the embodiment illustrated in FIG. 6 and FIG. 7A to FIG. 7H, the stacking relationship of the semiconductor layer 300, the first conductive layer 310, the second conductive layer 320, the third conductive layer 330 and the fourth conductive layer 340 can be referred to previous description. The embodiments illustrated in FIG. 6 and FIG. 7A to FIG. 7H have the following differences from the embodiment illustrated in FIG. 4.

Referring to FIG. 7A, the active layer of the data writing transistor T1 further includes an auxiliary extension portion 3 connected to the first extension portion 21 of the lateral portion 2 and extending towards one side facing the channel region of the data writing transistor T1 in the first direction D1. A certain space exists on the side of the lateral portion 2 of the active layer of the data writing transistor T1 close to the channel region of the data writing transistor T1 in the first direction D1, which is utilized to arrange the auxiliary extension portion 3 to further increase the length of the active layer of the data writing transistor T1 through the auxiliary extension portion 3, and further increase the distance between the drain electrode and the source electrode of the data writing transistor T1, thereby further increasing the equivalent power resistance of the data writing transistor T1, and further reducing the leakage current of the data writing transistor T1, therefore, the risk of leaking current of the first node G through the data writing transistor T1 can be further reduced, the resulting potential changing of the gate electrode (point G) of the driving transistor T5 can be reduced, and the above-mentioned screen flickering phenomenon on the display panel can be reduced or eliminated.

For example, the auxiliary extension portion 3 includes a first portion and a second portion, the first portion of the auxiliary extension portion 3 extends in the first direction D1, and the second portion of the auxiliary extension portion 3 is connected with the first portion of the auxiliary extension portion 3 and extends in the second direction D2 away from the longitudinal portion 1 to utilize the idle space here to further increase the length of the active layer of the data writing transistor T1 and further increase the distance between the drain electrode and the source electrode of the data writing transistor T1, thereby further increasing the equivalent resistance of the data writing transistor T1, and further reducing the leakage current of the data writing transistor T1.

Of course, the pattern of the auxiliary extension portion 3 is not limited to the situation illustrated in the figure, as long as the auxiliary extension portion 3 connected to the first extension portion 21 is provided in the space on one side of the lateral portion 2 of the active layer of the data writing transistor T1 close to the channel region of the active layer of the data writing transistor T1 in the first direction D1.

Further, for example, a spacing region exists between the gate electrode GE1 of the data writing transistor T1 and the lateral portion 2 of the active layer of the data writing transistor T1, and the auxiliary extension portion 3 is located in the spacing region. The auxiliary extension portion 3 is provided in the spacing region, which can utilize the idle space to further effectively increase the resistance of the active layer of the data writing transistor T1 and reduce the risk of leaking current of the first node G through the data writing transistor T1.

The auxiliary extension portion 3 is further located in the semiconductor layer 300, for example, the auxiliary extension portion 3, the first extension portion 21 and the longitudinal portion 1 constitute an integral structure.

For example, the spacing region exists between the gate electrode GE1 of the data writing transistor T1 and the lateral portion 2 of the active layer of the data writing transistor T1, and the auxiliary extension portion 3 is located in the spacing region. The extension portion is provided in the spacing region, which can utilize the idle space to further increase the resistance of the active layer of the data writing transistor T1.

For example, referring to FIG. 7F and FIG. 7G, the pixel circuit includes a first connection electrode L1, for example, the first connection electrode L1 is located in the third conductive layer 330; referring to FIG. 6, FIG. 7F and FIG. 7G, the auxiliary extension portion 3 is electrically connected to the first connection electrode L1 through the third via hole V3, and the first connection electrode L1 is electrically connected to the data signal line Data through the second via hole V2, so that both of the auxiliary extension portion 3 and the lateral portion 2 of the active layer of the transistor T1 are electrically connected to the data signal line Data, thereby achieving electrical connection between the data signal line Data and the active layer of the data writing transistor T1. In this case, the third via hole V3 serves as the above-mentioned second connection via hole. On the one hand, the electrical connection between the data signal line Data and the active layer of the data writing transistor T1 is realized through two via holes, that is, the third via hole V3 and the second via hole V2 which are arranged in the direction perpendicular to the main surface of the base substrate, the reliability of the electrical connection can be ensured, on the other hand, the auxiliary extension portion 3 is electrically connected to the data signal line Data through the first via hole V1, which is beneficial to increasing the effective length of the active layer of the data writing transistor T1.

For example, the third via hole V3 is located at an end portion of the auxiliary extension portion 3 away from the first extension portion 21 in the first direction D1. In this way, the length of the auxiliary extension portion 3 can be used to maximize the effective length of the active layer of the data writing transistor T1, both the length of the entire auxiliary extension portion 3 in the extension direction thereof and the length of the extension portion 21 in the second direction D2 can basically be used to increase the effective length of the active layer of the data writing transistor T1.

For example, referring to FIG. 7F and FIG. 7G, the pattern of the first connection electrode L1 is substantially the same as and coincident with the pattern of the lateral portion 2 of the active layer of the data writing transistor T1, that is, an orthographic projection of the first connection electrode L1 on the main surface of the base substrate substantially coincides with an orthographic projection of the lateral portion 2 of the active layer of the data writing transistor T1 on the main surface of the base substrate, so as to avoid the first connection electrode LI from occupying additional space and reduce the volume of the pixel circuit, which is beneficial to improving the PPI of the display substrate 10.

For example, in any embodiment of the present disclosure, the design of the first extension portion and the auxiliary extension portion of the data writing transistor T1 and/or the first extension portion of the first reset transistor can be applied to each sub-pixel P.

Other undescribed features of the embodiment illustrated in FIG. 6 and FIG. 7A to FIG. 7H are the same as those in the embodiment illustrated in FIG. 4 and will not be repeated here.

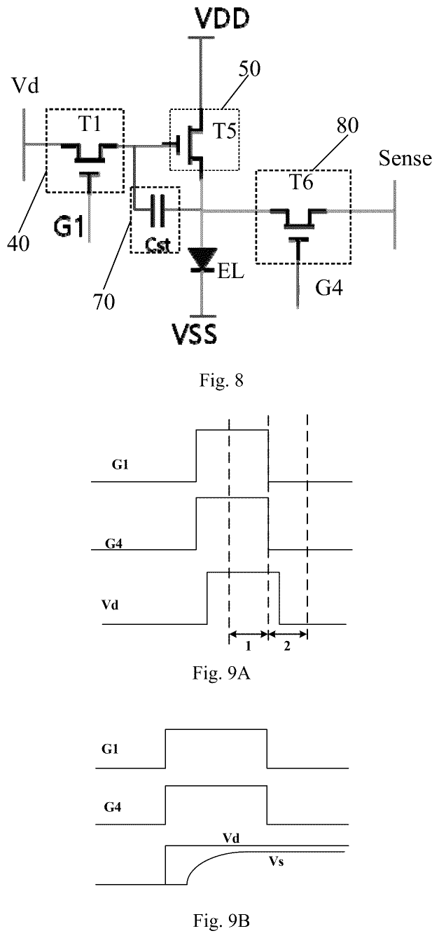

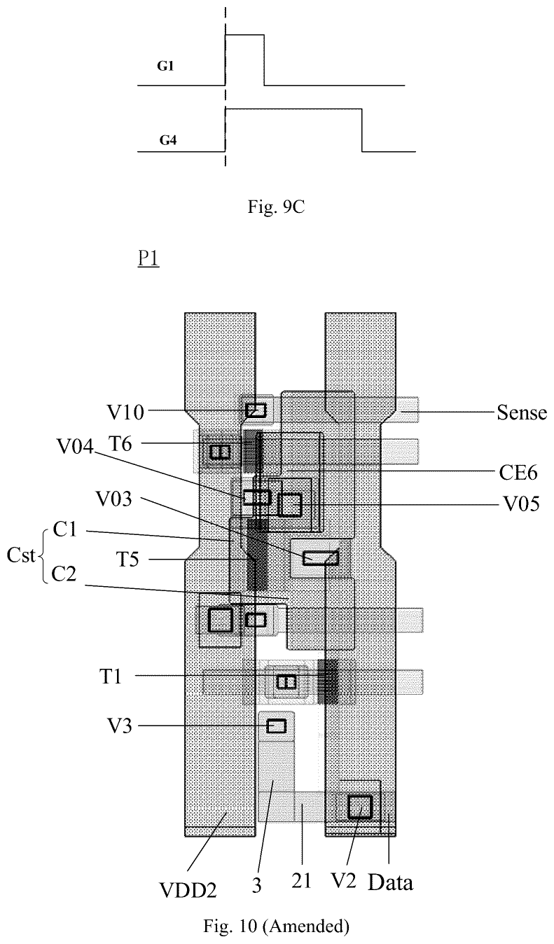

FIG. 8 is an equivalent circuit diagram of a pixel circuit of another sub-pixel provided by an embodiment of the present disclosure; FIG. 9A to FIG. 9C are timing diagrams of the pixel circuit illustrated in FIG. 8 during operation.

FIG. 8 illustrates a schematic diagram of a 3T1C pixel circuit used in the display substrate. As needed, the pixel circuit may further include a compensation circuit, a reset circuit and so on, which are not limited in the embodiments of the present disclosure.

Referring to FIG. 8, the pixel circuit includes a driving sub-circuit 50, a data writing sub-circuit 40, a storage sub-circuit 70, and a light-emitting element EL. The driving terminal of the driving sub-circuit 50 is electrically connected to a first terminal of the data writing sub-circuit 40, the data writing sub-circuit 40 is configured to receive a data signal Vd and write the data signal Vd to the driving terminal of the sub-circuit 50 and the storage sub-circuit 70 in response to the first control signal G1; the driving sub-circuit 50 is configured to control the current for driving the light-emitting element EL under the control of the voltage of its driving terminal.

Referring to FIG. 8, for example, the pixel circuit further includes a sensing sub-circuit 80, which is configured to detect the electrical property of the sub-pixel P to which the sensing transistor belongs in response to the second control signal G4.

The data writing sub-circuit 40 includes a data writing transistor T1, the driving sub-circuit 50 includes a driving transistor T5, the storage sub-circuit 70 includes a storage capacitor Cst, and the sensing sub-circuit 80 includes a sensing transistor T6. A first electrode of the data writing transistor T1 is electrically connected to a first capacitive electrode of the storage capacitor Cst and a gate electrode of the driving transistor T5, and a second electrode of the data writing transistor T1 is electrically connected to a data signal line to receive the data signal Vd; the second electrode of the data writing transistor T1 is configured to receive the data signal Vd, and the data write transistor T1 is configured to write the data signal Vd to the gate electrode of the driving transistor T5 and the storage capacitor Cst in response to the first control signal G1. A first electrode of the driving transistor T5 is electrically connected to the first capacitive electrode of the storage capacitor Cst and to a first electrode of the light-emitting element EL, a second electrode of the driving transistor T5 is electrically connected to a first power supply voltage terminal to receive a first power supply voltage VDD, the driving transistor T5 is configured to control the current for driving the light-emitting element EL under the control of the voltage of the gate electrode of the driving transistor T5. A first electrode of the sensing transistor T6 is electrically connected to the first electrode of the driving transistor T5 and a second capacitive electrode of the storage capacitor Cst, for example, the second electrode of the sensing transistor T6 is connected to a detection line Sense to connect to an external detection circuit, the sensing transistor T6 is configured to detect the electrical property of the associated sub-pixel P in response to the second control signal G4 to achieve external compensation. The electrical property includes, for example, the threshold voltage and/or carrier mobility of the driving transistor T5, or the threshold voltage and driving current of the light-emitting element. The external detection circuit 11 is, for example, a conventional circuit including a digital-to-analog converter (DAC), an analog-to-digital converter (ADC) and so on, which will not be described in detail in the embodiments of the present disclosure.

The operation principle of the pixel circuit illustrated in FIG. 9A will be described below in conjunction with the signal timing diagrams illustrated in FIG. 9A to FIG. 9C, FIG. 9A illustrates the signal timing diagram of the pixel circuit during the display process, FIG. 9B and FIG. 9C illustrate the signal timing diagrams of the pixel circuit during the detection process.

For example, as illustrated in FIG. 9A, the display process of each frame image includes a data writing and reset phase 1 and a light-emitting phase 2. FIG. 9A illustrates the timing waveform of each signal in each phase. The operation process of the 3T1C pixel circuit includes: in the data writing and reset phase 1, both a first control signal G1 and a second control signal G4 are turned-on signals, the data writing transistor T1 and the sensing transistor T6 are turned on, and the data signal Vd is transmitted to the gate electrode of the driving transistor T5 through the data writing transistor T1, for example, a reset signal is written to the first electrode of the light-emitting element (such as the anode of the OLED) by the analog-to-digital converter through the detection line Sense and the sensing transistor T6, the driving transistor T5 is turned on and generates the driving current to charge the first electrode of the light-emitting element EL to an operation voltage; in the light-emitting phase 2, both of the first control signal G1 and the second control signal G4 are turned-off signals, due to the bootstrap effect of the storage capacitor Cst, the voltage between two terminals of the storage capacitor Cst remains unchanged, the driving transistor T5 operates in a saturated state with unchanged current and drives the light-emitting element to emit light.

For example, FIG. 9A illustrates a signal timing diagram of the pixel circuit when detecting the threshold voltage. A working process of the 3T1C pixel circuit includes: both of the first control signal G1 and the second control signal G4 are turned-on signals, the data writing transistor T1 and the sensing transistor T6 are turned on, and the data signal Vd is transmitted through the data writing transistor T1 to the gate electrode of the driving transistor T5; a first switch K1 is turned off, the analog-to-digital converter writes a reset signal to the first electrode (node S) of the light-emitting element through the detection line Sense and the sensing transistor T6, the driving transistor T5 is turned on and the node S is charged until the first driving transistor is turned off, and the digital-to-analog converter samples the voltage on the detection line Sense to obtain the threshold voltage of the driving transistor T5. This process may be performed, for example, in the case where the display device is turned off.

For example, FIG. 9A illustrates a signal timing diagram of the pixel circuit when detecting the threshold voltage. The working process of the 3T1C pixel circuit includes: in the first phase, both of the first control signal G1 and the second control signal G4 are turned-on signals, the data writing transistor T1 and the sensing transistor T6 are turned on, and the data signal Vd is transmitted to the gate electrode of the driving transistor T5 through the data writing transistor T1; for example, the external analog-to-digital converter electrically connected to the detection line Sense is used to write the reset signal to the first electrode (node S) of the light-emitting element through the detection line Sense and the sensing transistor T6; in the second phase, the first control signal G1 is a turned-off signal, the second control signal G4 is a turned-on signal, the data writing transistor T1 is turned off, the sensing transistor T6 is turned on, and the detection line Sense is floated; due to the bootstrap effect of the storage capacitor Cst, the voltage between two terminals of the storage capacitor Cst remains unchanged, the driving transistor T5 works in saturated state with unchanged current and drives the light-emitting element to emit light. Then the digital-to-analog converter samples the voltage on the detection line Sense and The carrier mobility in the driving transistor T5 can be calculated based on the magnitude of the light-emitting current. For example, this process can be performed during the blanking phase between display phases.

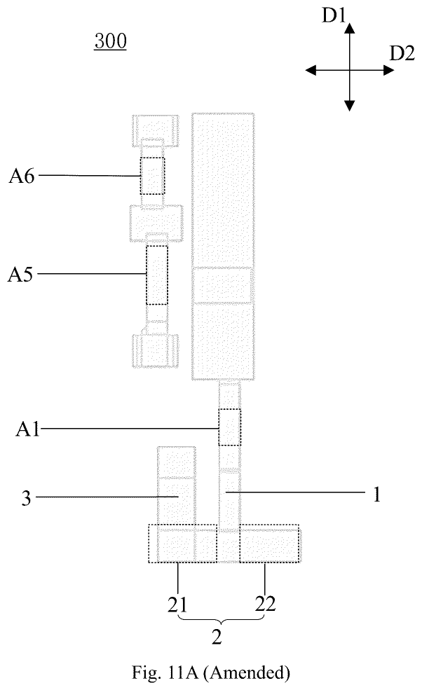

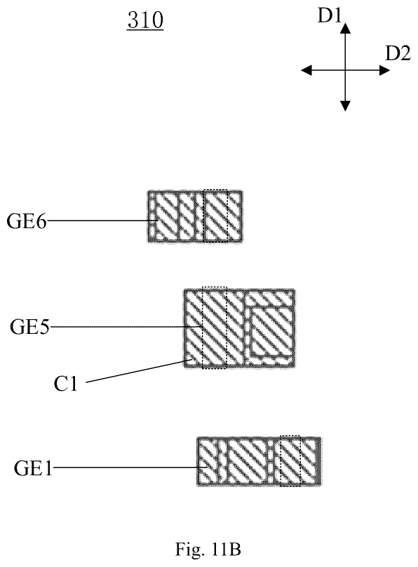

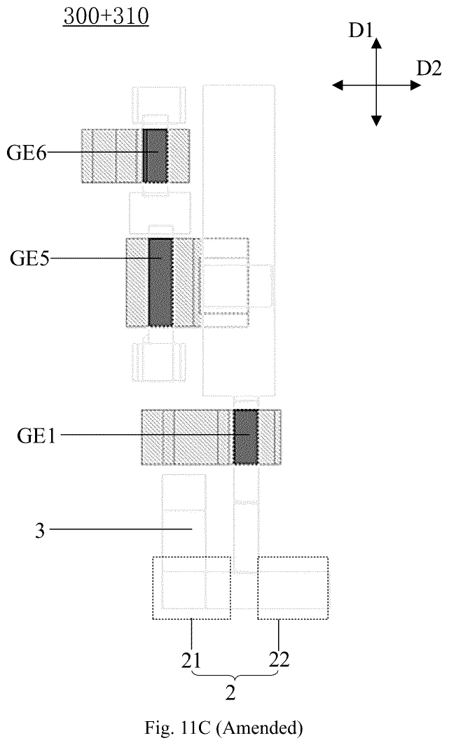

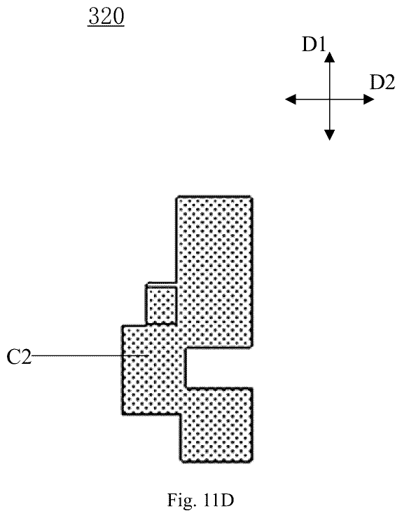

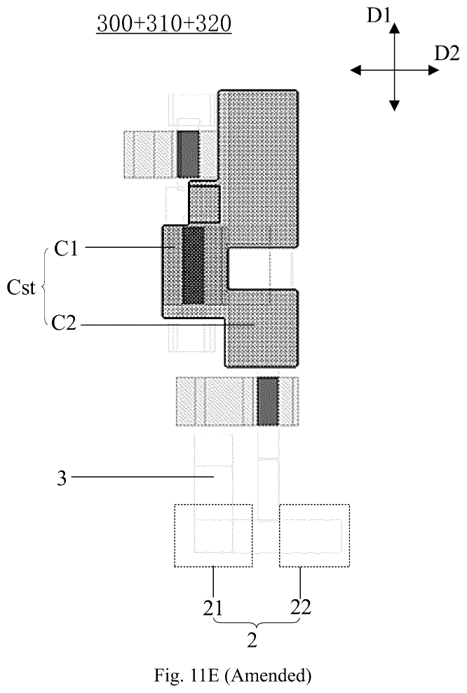

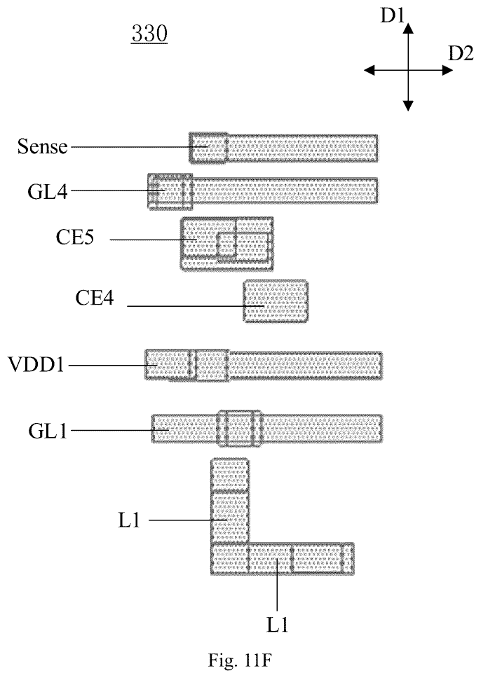

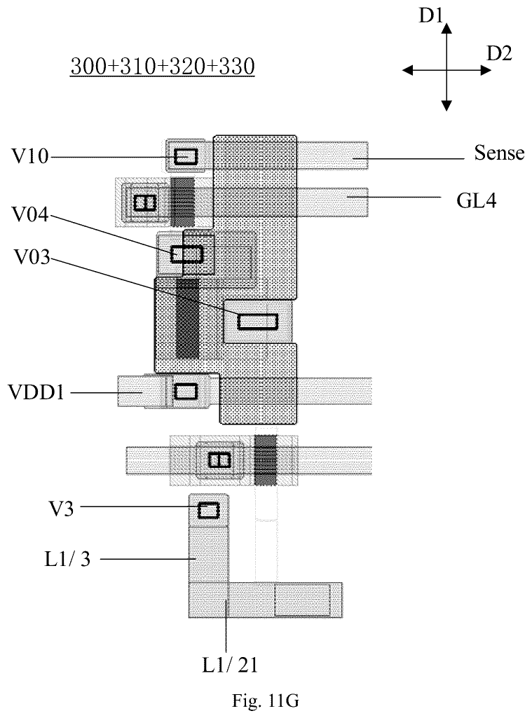

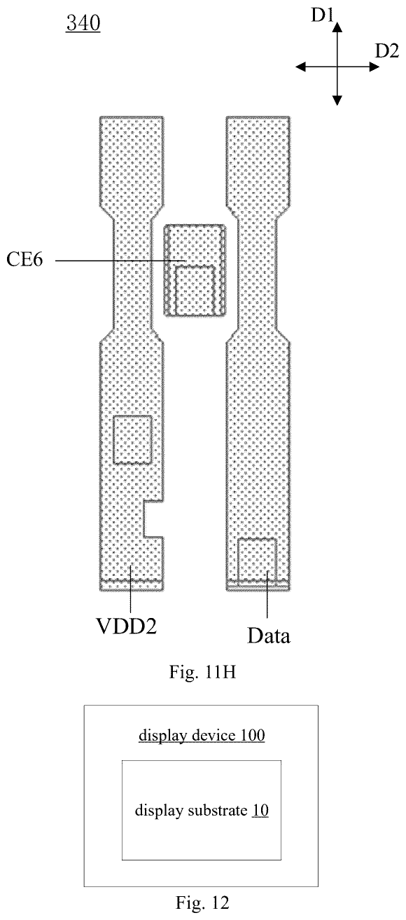

FIG. 10 is a schematic layout diagram of the pixel circuit illustrated in FIG. 8; FIG. 11A to FIG. 11H respectively illustrates a structural planar view of each layer of the pixel circuit illustrated in FIG. 10. In the embodiment illustrated in FIG. 10 and FIG. 11A to FIG. 11H, the stacking relationship of the semiconductor layer 300, the first conductive layer 310, the second conductive layer 320, the third conductive layer 330 and the fourth conductive layer 340 can be referred to previous description. The embodiment illustrated in FIG. 10 and FIG. 11A to FIG. 11H has the following differences from the embodiment illustrated in FIG. 6.

FIG. 10 illustrates a schematic structural layout diagram of a sub-pixel P. For example, referring to FIG. 11A, the active layer of each transistor of the sub-pixel P is located in the semiconductor layer 300, and the active layer of each transistor of the sub-pixel P includes a channel region A1, a channel region A5, and a channel region A6 respectively; referring to FIG. 11B, a gate electrode GE1, a gate electrode GE5, and a gate electrode GE6 of each transistor of the sub-pixel P and the first capacitive electrode C1 of the storage capacitor Cst are located in the first conductive layer 310; referring to FIG. 11D, the second capacitive electrode C2 of the storage capacitor Cst of the sub-pixel P is located in the second conductive layer 320; referring to FIG. 11F, the detection line Sense, a first gate line GL1 electrically connected to the gate electrode GE1 of the data writing transistor T1 to provide the first control signal G1, a second gate line GL4 electrically connected to the gate electrode GE6 of the sensing transistor T6 to provide the second control signal G4, a lateral power supply line VDD1, a first connection electrode, a connection block CE4 and a connection block CE5 are located in the third conductive layer 330, the structures and function of the connection block CE4 and the connection block CE5 are similar to the first connection block CE1 and the second connection block CE2 in the embodiment illustrated in FIG. 4; referring to FIG. 5H, the longitudinal power supply line VDD2, the data signal line Data and the connection block CE6 are located in the fourth conductive layer 340, the structures and function of the connection block CE6 are similar to the third connection block CEO in the embodiment illustrated in FIG. 4, which is used for electrical connection with the first electrode of the light-emitting element.

For example, in this 3T1C circuit, the above-mentioned control transistor includes the data writing transistor T1. The structure of the data writing transistor T1 is introduced below by taking the control transistor including the data writing transistor T1 as an example.

Referring to FIG. 10 and FIG. 11A, the channel region A5 of the driving transistor T5 and the channel region A1 of the data writing transistor T1 are arranged in a first direction D1, and a second direction D2 intersects with the first direction D1, for example the second direction D2 is perpendicular to the first direction D1. Referring to FIG. 11A, the active layer of the data writing transistor T1 includes a longitudinal portion 1 extending in the first direction D1 and a lateral portion 2 extending in the second direction D2, the longitudinal portion 1 includes the channel region A1 of the data writing transistor T1, that is, the longitudinal portion 1 includes the channel region of the control transistor. The lateral portion 2 is connected to the longitudinal portion 1, the lateral portion 2 includes a first extension portion 21 and a second extension portion 22, and the first extension portion 21 protrudes from the longitudinal portion 1 towards a first side in the second direction D2, the second extension portion 22 protrudes from the longitudinal portion 1 in a second direction D2 towards a second side opposite to the first side. In this way, the length of the active layer of the data writing transistor T1 is increased, and the distance between the drain electrode and the source electrode of the data writing transistor T1 is increased, thereby increasing the equivalent resistance of the data writing transistor T1, and reducing the leakage current of the data writing transistor T1, therefore, the risk of leaking current of the node G through the data writing transistor T1 in the turned-off state can be reduced, the resulting potential changing of the gate electrode of the driving transistor T5 (point G) can be reduced, and the above-mentioned screen flickering phenomenon on the display panel can be reduced or eliminated.

For example, referring to FIG. 11A, the channel region A5 of the driving transistor T5 is located on the first side of the longitudinal portion 1 in the second direction D2, and the length of the first extension portion 21 in the second direction D2 is not less than the length of the second extension portion 22 in the second direction D2, thereby making full use of the space on the first side of the longitudinal portion 1 in the second direction D2 to extend the length of the active layer of the data writing transistor T1, so as to utilize the limited space as much as possible to reduce the leakage current of the data writing transistor T1 and reduce the risk of leaking current of the first node G through the data writing transistor T1. For example, the length of the first extension portion 21 in the second direction D2 is not greater than the length of the second extension portion 22 in the second direction D2, or the length of the first extension portion 21 in the second direction D2 is substantially equal to the length of the second extension portion 22 in the second direction D2.

For example, referring to FIG. 11A, the longitudinal portion 1 has a distal end away from the channel region A5 of the driving transistor T5 in the first direction D1, and the first extension portion 21 and the second extension portion 22 are located at the distal end of the longitudinal portion 1 and are connected to the distal end of the longitudinal portion 1. In this way, the longitudinal portion 1 extending in the first direction D1 can be used to form the channel region A1 of the data writing transistor T1, and the lateral portion 2 can further be arranged in the space created on both sides of the distal end of the longitudinal portion 1 in the second direction D2, the space can be reasonably utilized to realize the structure of the data writing transistor T1 and increase the length of the active layer of the data writing transistor T1 to increase the equivalent resistance of the data writing transistor T1.

For example, referring to FIG. 11A, the first extension portion 21 of the active layer of the data writing transistor T1 at least partially overlaps with the channel region A5 of the driving transistor T5 in the first direction D1. Therefore, the space in the second direction D2 is utilized to appropriately increase the length of the first extension portion 21, in the second direction D2, the first extension portion 21 extends at least to the position where the channel region A5 of the driving transistor T5 is located, which can not only make the leakage current of the data writing transistor T1 reach an appropriate value and achieve the effect of fully reducing the leakage current of the data writing transistor T1, but also do not occupy the arrangement space of other structures of the pixel circuit, the normal function of the pixel circuit can be ensured to ensure display quality.

Referring to FIG. 11A, the active layer of the data writing transistor T1 further includes an auxiliary extension portion 3 connected to the first extension portion 21 of the lateral portion 2 and extending in the first direction D1 towards a side, of the first extension portion 21, on which the channel region of the data writing transistor T1 is located. A certain space exists on the side of the lateral portion 2 of the active layer of the data writing transistor T1 close to the channel region of the data writing transistor T1 in the first direction D1, which is utilized to arrange the auxiliary extension portion 3 to further increase the length of the active layer of the data writing transistor T1 through the auxiliary extension portion 3, and further increase the distance between the drain electrode and the source electrode of the data writing transistor T1, thereby further increasing the equivalent power resistance of the data writing transistor T1, and further reducing the leakage current of the data writing transistor T1, therefore, the risk of leaking current of the first node G through the data writing transistor T1 can be further reduced, the resulting potential changing of the gate electrode (point G) of the driving transistor T5 can be reduced, and the above-mentioned screen flickering phenomenon on the display panel can be reduced or eliminated.

Of course, the pattern of the auxiliary extension portion 3 is not limited to the situation illustrated in the figure, as long as the auxiliary extension portion 3 connected to the first extension portion 21 is provided in the space on one side of the lateral portion 2 of the active layer of the data writing transistor T1 close to the channel region of the active layer of the data writing transistor T1 in the first direction D1.

Further, for example, a spacing region exists between the gate electrode GE1 of the data writing transistor T1 and the lateral portion 2 of the active layer of the data writing transistor T1, and the auxiliary extension portion 3 is located in the spacing region. The auxiliary extension portion 3 is provided in the spacing region, which can utilize the idle space to further effectively increase the resistance of the active layer of the data writing transistor T1 and reduce the risk of leaking current of the first node G through the data writing transistor T1.

The auxiliary extension portion 3 is further located in the semiconductor layer 300, for example, the auxiliary extension portion 3, the first extension portion 21 and the longitudinal portion 1 constitute an integral structure.

For example, the spacing region exists between the gate electrode GE1 of the data writing transistor T1 and the lateral portion 2 of the active layer of the data writing transistor T1, and the auxiliary extension portion 3 is located in the spacing region. The extension portion 3 is provided in the spacing region, which can utilize the idle space to further increase the resistance of the active layer of the data writing transistor T1.

Referring to FIG. 11A and FIG. 11G, a connection position of the first electrode of the data writing transistor T1 and the active layer of the first electrode of the data writing transistor T1 is a first sub-position, and a connection position of the second electrode of the data writing transistor T1 and the active layer of the writing transistor T1 is a second position, that is, in the case where the data writing transistor T1 serves as the control transistor, the first sub-position serves as the above-mentioned first position, and the second sub-position serves as the above-mentioned second position. The connection position of the first electrode of the driving transistor T5 and the active layer of the driving transistor T5 is the third position, and the distance between the first sub-position and the second sub-position is greater than the distance between the first sub-position and the third position, so that a length of the active layer of the data writing transistor T1 and the distance between the source electrode and the drain electrode of the data writing transistor T1 can be increased, thereby increasing the equivalent resistance of the data writing transistor T1 and reducing the leakage current of the writing transistor T1, therefore, the risk of leaking current of the first node G through the writing transistor T1 in the turned-off state, the resulting potential changing of the gate electrode of the driving transistor T5 (the node G) can be reduced, and the above-mentioned screen flickering phenomenon on the display panel can be reduced or eliminated.

For example, a linear distance between the first sub-position and the second sub-position is greater than a linear distance between the first sub-position and the third position; or, a distance between the first sub-position and the second sub-position in the first direction D1 is greater than a distance between the first sub-position and the third position in the first direction D1, or, a sum of the distance between the first sub-position and the second sub-position in the first direction D1 and a distance between the first sub-position and the second sub-position in the second direction D2 is greater than a sum of the distance between the first sub-position and the third position in the first direction D1 and a distance between the first sub-position and the third position in the second direction D2.

For example, referring to FIG. 10 and FIG. 11F to FIG. 11G, the first capacitive electrode C1 of the storage capacitor Cst and the gate electrode of the driving transistor T5 constitute an integral structure, the sub-pixel P1 includes a first connection block CE4, for example, the first connection block CE4 is located in the third conductive layer 330; the first connection block CE4 is electrically connected to the gate electrode of the driving transistor T5 through a first connection via hole V03, that is, electrically connected to the first capacitive electrode C1 of the storage capacitor Cst; a part of the first connection via hole V03 exposes a part of the semiconductor layer 300, because the active layers of the transistors of the pixel circuit constitute an integral structure, a part of the first connection via hole V03 exposes a part of the active layer of the data writing transistor T1, the first connection block CE4 is electrically connected to the active layer of the data writing transistor T1 through the first connection via hole V03, referring to FIG. 5A, because the active layer of the data writing transistor T1 and the active layer of the driving transistor T5 form a continuous integrated structure, the first connection block CE4 is further electrically connected to the active layer of the driving transistor T5 through the first connection via hole V03. Therefore, the first connection block CE4 serves as the first electrode of the data writing transistor T1, and realizes that the first capacitive electrode C1 of the storage capacitor Cst, the gate electrode GE5 of the driving transistor T5 and the first electrode of the data writing transistor T1 are electrically connected to the first node G, the position of the first connection via hole V03 is the above-mentioned first sub-position.

For example, the second electrode of the data writing transistor T1 is electrically connected to the active layer of the data writing transistor T1 through a second connection via hole, and the position of the second connection via hole is the second sub-position.

For example, referring to FIGS. 11F and 11G, the pixel circuit includes a first connection electrode L1, for example, the first connection electrode L1 is located in the third conductive layer 330; referring to FIG. 10, FIG. 11F and FIG. 11G, the auxiliary extension portion 3 is electrically connected to the first connection electrode L1 through the third via hole V3, and the first connection electrode L1 is electrically connected to the data signal line Data through the second via hole V2, so that both of the auxiliary extension portion 3 and the lateral portion 2 of the active layer of the transistor T1 are electrically connected to the data signal line Data, thereby achieving electrical connection between the data signal line Data and the active layer of the data writing transistor T1. In this case, the third via hole V3 serves as the above-mentioned second connection via hole in the case where the control transistor is the data writing transistor T1, therefore, the position of the third via hole V3 is above-mentioned second sub-position. On the one hand, the electrical connection between the data signal line Data and the active layer of the data writing transistor T1 is realized through two via holes, that is, the third via hole V3 and the second via hole V2 which are arranged in the direction perpendicular to the main surface of the base substrate, the reliability of the electrical connection can be ensured, on the other hand, the auxiliary extension portion 3 is electrically connected to the data signal line Data through the third via hole V3 and the first connection electrode L1, which is beneficial to further increasing the effective length of the active layer of the data writing transistor T1.

For example, the third via hole V3 is located at an end portion of the auxiliary extension portion 3 away from the lateral portion 2 in the first direction D1. In this way, the length of the auxiliary extension portion 3 can be used to maximize the effective length of the active layer of the data writing transistor T1, both the length of the entire auxiliary extension portion 3 in the extension direction and the length of the extension portion 21 in the second direction D2 can basically be used to increase the effective length of the active layer of the data writing transistor T1.

For example, referring to FIG. 11F and FIG. 11G, the pattern of the first connection electrode L1 is substantially the same as and coincident with the pattern of the lateral portion 2 of the active layer of the data writing transistor T1, that is, an orthographic projection of the first connection electrode L1 on the main surface of the base substrate substantially coincides with an orthographic projection of the lateral portion 2 of the active layer of the data writing transistor T1 on the main surface of the base substrate, so as to avoid the first connection electrode L1 from occupying additional space and reduce the volume of the pixel circuit, which is beneficial to improving the PPI of the display substrate 10.

Of course, in the structure of the 3T1C circuit provided by other embodiments, the auxiliary extension portion 3 can further be removed in FIG. 11A, in this case, the first via hole V1 similar to the embodiment illustrated in FIG. 4 can be used to achieve electrical connection between the first connection electrode L1 and the first extension portion 21.

The connection position of the first electrode of the sensing transistor T6 and the active layer of the sensing transistor T6 is a fifth sub-position, and a connection position of the second electrode of the sensing transistor T6 and the active layer of the sensing transistor T6 is a sixth sub-position; the distance between the first sub-position and the second sub-position is greater than the distance between the fifth sub-position and the sixth sub-position, so as to further increase the length of the active layer of the data writing transistor T1 and increase the distance between the source electrode and the drain electrode of the data writing transistor T1, thereby increasing the equivalent resistance of the data writing transistor T1 and reducing the leakage current of the data writing transistor T1.

Other undescribed features and corresponding technical effects of the embodiments illustrated in FIG. 8, FIG. 10, and FIG. 11A to FIG. 11H, such as the relationship between the distance between the first position and the second position and the pixel width, etc., are the same as those illustrated in FIG. 4, which will not be repeated here.

Of course, in other embodiments of the display substrate provided by the present disclosure, the pixel circuit can further be a 7T1C circuit or an 8T1C circuit, as long as it includes a transistor electrically connected to the first node G, the technical solution of the above-mentioned first extension portion and/or the auxiliary extension portion can be applied to the transistor to reduce the leakage current of the transistor electrically connected to the first node G, so as to prevent display defects caused by unnecessary changes in the voltage of the first node G during the light-emitting phase.

As illustrated in FIG. 12, at least one embodiment of the present disclosure further provides a display device 100, as illustrated in FIG. 12, the display device 100 includes any one of the display substrates 10 provided by the embodiments of the present disclosure. The display device 100 may be, for example, a device with a display function such as an organic light-emitting diode display device and a quantum dot light-emitting diode display device, or other devices, the embodiments of the present disclosure do not limit this.

For the structure, function and technical effect of the display device provided by the embodiment of the present disclosure, reference can be made to the corresponding description of the display substrate 10 provided by the embodiment of the present disclosure, which will not be described again here.

For example, the display device 100 provided by at least one embodiment of the present disclosure can be any other product or component with a display function, such as a display panel, a mobile phone, a tablet computer, a television, a monitor, a notebook computer, a digital photo frame, a navigator and so on, the embodiments of the present disclosure do not limit this.

For the present disclosure, the following statements should be noted:
(1) The accompanying drawings involve only the structure(s) in connection with the embodiment(s) of the present disclosure, and other structure(s) can be referred to common design(s).
(2) In case of no conflict, the embodiments of the present disclosure and the features in the embodiments can be combined with each other to obtain new embodiments.

What have been described above are only specific implementations of the present disclosure, the protection scope of the present disclosure is not limited thereto, and the protection scope of the present disclosure should be based on the protection scope of the claims.

1. A display substrate, comprising a sub-pixel, and the sub-pixel comprising a pixel circuit, wherein the pixel circuit comprises a driving sub-circuit, a light-emitting element and a control sub-circuit, the driving sub-circuit comprises a driving transistor, a gate electrode of the driving transistor is configured to receive a driving control signal, and the driving sub-circuit is configured to control a magnitude of driving current flowing through the light-emitting element in response to the driving control signal;
the control sub-circuit comprises a control transistor, a first electrode of the control transistor is electrically connected to the gate electrode of the driving transistor;
a connection position of the first electrode of the control transistor and an active layer of the control transistor is a first position, and a connection position of a second electrode of the control transistor and the active layer of the control transistor is a second position, a connection position of a first electrode of the driving transistor and an active layer of the driving transistor is a third position, and a distance between the first position and the second position is greater than a distance between the first position and the third position.

2. The display substrate according to claim 1, wherein a linear distance between the first position and the second position is greater than a linear distance between the first position and the third position, or,
a distance between the first position and the second position in the first direction is greater than a distance between the first position and the third position in the first direction, or,
a sum of the distance between the first position and the second position in the first direction and a distance between the first position and the second position in the second direction is greater than a sum of the distance between the first position and the third position in the first direction and a distance between the first position and the third position in the second direction.

3. The display substrate according to claim 1, wherein the sub-pixel comprises a first connection block, the first connection block is electrically connected to the gate electrode of the driving transistor, and the active layer of the control transistor through a first connection via hole, and a position of the first connection via hole is the first position;
the second electrode of the control transistor is electrically connected to the active layer of the control transistor through a second connection via hole, and a position of the second connection via hole is the second position;
the sub-pixel comprises a second connection block, the second connection block is electrically connected to the active layer of the driving transistor through a third connection via hole, and a position of the third connection via hole is the third position.

4. The display substrate according to claim 3, wherein a channel region of the driving transistor and a channel region of the control transistor are arranged in a first direction, and a second direction intersects with the first direction, the active layer of the control transistor comprises a longitudinal portion extending in the first direction and a lateral portion extending in the second direction, the longitudinal portion comprises the channel region of the control transistor;
the lateral portion is connected to the longitudinal portion, the lateral portion comprises a first extension portion and a second extension portion, the first extension portion protrudes from the longitudinal portion toward a first side in the second direction, the second extension portion protrudes from the longitudinal portion toward a second side opposite to the first side in the second direction.

5. The display substrate according to claim 4, wherein the channel region of the driving transistor is located on the first side of the longitudinal portion in the second direction, and a length of the first extension portion in the second direction is not less than a length of the second extension portion in the second direction.

6. The display substrate according to claim 5, wherein the longitudinal portion has a distal end away from the channel region of the driving transistor in the first direction, the first extension portion and the second extension portion are located at the distal end of the longitudinal portion and connected with the distal end of the longitudinal portion.

7. The display substrate according to claim 4, wherein the pixel circuit comprises a data writing sub-circuit, the data writing sub-circuit comprises a data writing transistor, the control transistor comprises the data writing transistor, and the data writing transistor serves as the control transistor;
a gate electrode of the data writing transistor is electrically connected to a data writing control signal terminal to receive a data writing control signal, a first electrode of the data writing transistor is electrically connected to the gate electrode of the driving transistor, a second electrode of the data writing transistor is configured to receive a data signal, and the data writing sub-circuit is configured to write the data signal to the gate electrode of the driving transistor in response to the data writing control signal.

8. The display substrate according to claim 7, wherein the first extension portion of an active layer of the data writing transistor at least partially overlaps with the channel region of the driving transistor in the first direction.

9. The display substrate according to claim 7, wherein the display substrate comprises a data signal line providing the data signal, and the lateral portion of the active layer of the data writing transistor is electrically connected to the data signal line;
the pixel circuit comprises a first connection electrode arranged in a layer different from both the active layer of the data writing transistor and the data signal line, and the first extension portion of the lateral portion is electrically connected to the first connection electrode through a first via hole, the first connection electrode is electrically connected to the data signal line through a second via hole, and the first via hole serves as the second connection via hole in a case where the control transistor is the data writing transistor;
the first via hole is located at an end portion of the first extension portion away from the longitudinal portion in the second direction.

10. (canceled)

11. The display substrate according to claim 7, wherein an active layer of the data writing transistor further comprises an auxiliary extension portion, the auxiliary extension portion is connected to the first extension portion of the lateral portion and extends in the first direction toward a side, of the first extension portion, on which a channel region of the data writing transistor is located;
a spacing region exists between the gate electrode of the data writing transistor and the lateral portion of the active layer of the data writing transistor, and the auxiliary extension portion is located in the spacing region.

12. (canceled)

13. The display substrate according to claim 11, wherein the display substrate comprises a data signal line providing the data signal, and a lateral portion of the active layer of the data writing transistor is electrically connected to the data signal line;
the pixel circuit comprises a first connection electrode arranged in a layer different from both the active layer and the data signal line, the auxiliary extension portion is electrically connected to the first connection electrode through a third via hole, and the first connection electrode is electrically connected to the data signal line through a second via hole, and the third via hole serves as the second connection via hole in a case where the control transistor is the data writing transistor;
the third via hole is located at an end portion of the auxiliary extension portion away from the first extension portion in the first direction.

14. (canceled)

15. The display substrate according to claim 11, 14, wherein the display substrate comprises a plurality of the sub-pixels, and the plurality of sub-pixels comprise a first sub-pixel and a second sub-pixel that are adjacent in the second direction;
a gate electrode of the data writing transistor of the first sub-pixel and a gate electrode of the data writing transistor of the second sub-pixel are independent of each other to receive different data writing control signals respectively;
the display substrate comprises a first auxiliary gate line arranged in a layer different from the gate electrode of the data writing transistor of the first sub-pixel, and the first auxiliary gate line is electrically connected to the gate electrode of the data writing transistor of the first sub-pixel through a fourth via hole;
the display substrate comprises a second auxiliary gate line arranged in a layer different from the gate electrode of the data writing transistor of the second sub-pixel, and the second auxiliary gate line is electrically connected to the gate electrode of the data writing transistor of the second sub-pixel through a fifth via hole.

16. The display substrate according to claim 15, wherein the first extension portion of the active layer of the data writing transistor at least partially overlaps with the fourth via hole in the first direction.

17. The display substrate according to claim 15, wherein a gate electrode of a common-gate transistor of the first sub-pixel and a gate electrode of a common-gate transistor of the second sub-pixel are electrically connected to each other to share with a same gate scan signal, the common-gate transistor comprises at least one of transistors in the pixel circuit other than the data writing transistor and the driving transistor;
the display substrate comprises a second connection electrode arranged in a layer different from the gate electrode of the common-gate transistor, and the second connection electrode is electrically connected to the gate electrode of the common-gate transistor of the first sub-pixel through a sixth via hole, and electrically connected to the gate electrode of the common-gate transistor of the second sub-pixel through a seventh via hole;
the display substrate comprises a data signal line providing the data signal, and a lateral portion of the active layer of the data writing transistor is electrically connected to the data signal line, and the pixel circuit comprises a first connection electrode arranged in a layer different from both the active layer and the data signal line, and the first extension portion of the lateral portion is electrically connected to the first connection electrode through a first via hole, the first connection electrode is electrically connected to the data signal line through a second via hole,
the first auxiliary gate line, the second auxiliary gate line, and the second connection electrode are all arranged in a same layer as the first connection electrode.

18. The display substrate according to claim 7, wherein the pixel circuit comprises a first reset sub-circuit, the first reset sub-circuit comprises a first reset transistor, the control transistor comprises the first reset transistor, and the first reset transistor also serves as the control transistor;
a gate electrode of the first reset transistor is electrically connected to a first reset signal terminal to receive a first reset control signal, a first electrode of the first reset transistor is electrically connected to the gate electrode of the driving transistor, a second electrode of the reset transistor is electrically connected to a first signal terminal, and the first reset sub-circuit is configured to write a first reset signal from the first signal terminal to the gate electrode of the driving transistor in response to the first reset control signal.

19. The display substrate according to claim 18, wherein a connection position of the first electrode of the data writing transistor and an active layer of the data writing transistor is a first sub-position, and a connection position of the second electrode of the data writing transistor and the active layer of the data writing transistor is a second sub-position; a connection position of the first electrode of the first reset transistor and an active layer of the first reset transistor is a third sub-position, and a connection position of the second electrode of the first reset transistor and the active layer of the first reset transistor is a fourth sub-position;
a distance between the first sub-position and the second sub-position is greater than a distance between the third sub-position and the fourth sub-position.

20. The display substrate according to claim 19, wherein the active layer of the data writing transistor extends from the first sub-position to the second sub-position, and the active layer of the first reset transistor extends from the third sub-position to the fourth sub-position, a total length of the active layer of the data writing transistor from the first sub-position to the second sub-position is greater than a total length of the active layer of the first reset transistor from the third sub-position to the fourth sub-position.

21. The display substrate according to claim 18, wherein the first extension portion of the active layer of the first reset transistor at least partially overlaps with the channel region of the driving transistor in the first direction.

22. The display substrate according to claim 18, wherein in the case where the control transistor comprises the data writing transistor, in the first direction, the channel region of the driving transistor is located between a channel region of the data writing transistor and a channel region of the first reset transistor;
in the first direction, the lateral portion of the active layer of the data writing transistor is located on a side of the channel region of the data writing transistor away from the channel region of the driving transistor, and the lateral portion of the active layer of the first reset transistor is located on a side of the channel region of the first reset transistor away from the channel region of the driving transistor.

23-30. (canceled)

31. A display device, comprising the display substrate according to claim 1.
